(19) United States
(12) Patent Application Publication
(10) Pub. No.: US 2026/0279362 A1
(43) Pub. Date: Sep. 17, 2026

(54) INFORMATION PROCESSING APPARATUS, METHOD, AND PROGRAM

(71) Applicant: SONY GROUP CORPORATION, Tokyo (JP)

(72) Inventors: Ryuichi NAMBA, Tokyo (JP); Hiroyuki HONMA, Tokyo (JP); Toru CHINEN, Tokyo (JP); Mitsuyuki HATANAKA, Tokyo (JP)

(21) Appl. No.: 19/472,818

(22) PCT Filed: Sep. 22, 2023
(86) PCT No.: PCT/JP2023/034422

§ 371 Date: Oct. 6, 2025

Related U.S. Application Data
(60) Provisional application No. 63/496,096, filed on Apr. 14, 2023.
(60) Provisional application No. 63/496,470, filed on Apr. 17, 2023.

(51) Int. Cl. G10L 19/008; H04S 7/00

(52) U.S. Cl. CPC G10L 19/008; H04S 7/302

(57) ABSTRACT

The present technology relates to an information processing apparatus, a method, and a program capable of reducing a data transmission amount. An information processing apparatus includes: an acquisition unit that acquires target data at a recording data point among a plurality of data points arranged on a spherical surface, and recording point restoration information for specifying the data point serving as the recording data point; and a calculation unit that specifies the data point serving as the recording data point on the basis of the recording point restoration information, and calculates the target data at a position different from the recording data point on the basis of the target data at the recording data point. The present technology can be applied to an information processing apparatus.

### TECHNICAL FIELD

The present technology relates to an information processing apparatus, a method, and a program, and more particularly, to an information processing apparatus, a method, and a program capable of reducing a data transmission amount.

### BACKGROUND ART

Conventionally, it is known that audio reproduction with a higher realistic feeling can be realized by considering directivity of a sound source.

For example, if directivity data representing directivity of sound from an object is prepared together with audio data of the object, audio reproduction based on directional characteristics of the object can be performed using the audio data and the directivity data.

Furthermore, as a technology regarding directivity, for example, a technology has been proposed in which a user can perform recording by arbitrarily selecting a directivity direction at the time of recording, and at the time of reproduction, the user selects and reproduces a desired directivity direction separately from the directivity direction at the time of recording (see, for example, Patent Document 1).

### CITATION LIST

### Patent Document

Patent Document 1: Japanese Patent Application Laid-Open No. 2021-100209

### SUMMARY OF THE INVENTION

### Problems to be Solved by the Invention

Meanwhile, in a case where audio data of an object and directivity data of the object are provided as content, if information regarding directivity is provided for more directions and frequencies, a data amount of the directivity data increases. Then, the transmission amount of the directivity data to the distribution destination of the content increases, and there is a possibility that a transmission delay occurs or a transmission rate increases.

The present technology has been made in view of such a situation, and is intended to reduce the amount of data transmission.

### Solutions to Problems

An information processing apparatus according to a first aspect of the present technology includes: an acquisition unit that acquires target data at a recording data point among a plurality of data points arranged on a spherical surface, and recording point restoration information for specifying the data point serving as the recording data point; and a calculation unit that specifies the data point serving as the recording data point on the basis of the recording point restoration information, and calculates the target data at a position different from the recording data point on the basis of the target data at the recording data point.

An information processing method or a program according to the first aspect of the present technology includes the steps of: acquiring target data at a recording data point among a plurality of data points arranged on a spherical surface, and recording point restoration information for specifying the data point serving as the recording data point; specifying the data point serving as the recording data point on the basis of the recording point restoration information; and calculating the target data at a position different from the recording data point on the basis of the target data at the recording data point.

In the first aspect of the present technology, target data at a recording data point among a plurality of data points arranged on a spherical surface, and recording point restoration information for specifying the data point serving as the recording data point are acquired, and the data point serving as the recording data point specified on the basis of the recording point restoration information, and calculating the target data at a position different from the recording data point is calculated on the basis of the target data at the recording data point.

An information processing apparatus according to a second aspect of the present technology includes: a generation unit that determines one or a plurality of recording data points from among a plurality of data points arranged on a spherical surface, and generates recording point restoration information for specifying the data points set as the recording data points; and an output unit that outputs a bit stream including the recording point restoration information and target data at the recording data points.

In the second aspect of the present technology, one or a plurality of recording data points is determined from among a plurality of data points arranged on a spherical surface, and recording point restoration information for specifying the data points set as the recording data points is generated, and a bit stream including the recording point restoration information and target data at the recording data points is output.

### BRIEF DESCRIPTION OF DRAWINGS

FIG. 1 is a diagram for explaining threshold processing on a mixture model.

FIG. 2 is a diagram for explaining selection of recording data points.

FIG. 3 is a diagram for explaining discretization of a mixture model.

FIG. 4 is a diagram for explaining AM modulation to the mixture model.

FIG. 5 is a diagram for explaining thinning using symmetry.

FIG. 6 is a diagram illustrating a syntax example of recording region specifying information.

FIG. 7 is a diagram illustrating a configuration example of a server.

FIG. 8 is a flowchart illustrating coding processing.

FIG. 9 is a flowchart for explaining thinning processing.

FIG. 10 is a diagram illustrating a configuration example of an information processing apparatus.

FIG. 11 is a flowchart illustrating directivity data generation processing.

FIG. 12 is a flowchart illustrating data point interpolation processing.

FIG. 13 is a flowchart for explaining output audio data generation processing.

FIG. 14 is a diagram illustrating a configuration example of a computer.

### MODE FOR CARRYING OUT THE INVENTION

Embodiments to which the present technology is applied will be described hereinafter with reference to the drawings.

### First Embodiment

### <Present Technology>

The present technology is to reduce a data transmission amount when data having values at a plurality of positions in space as data points is transmitted as the data points.

The data to be transmitted may be any data as long as the data has values at a plurality of positions in space, for example, on a spherical surface.

For example, as examples of the data to be transmitted, directivity data, data related to weather, data related to a head related transfer function (HRTF), and the like can be considered. Hereinafter, as a specific example, a case where the directivity data representing the directional characteristic of the sound source prepared for each sound source type is set as the transmission target will be described.

The directivity data to be transmitted is, for example, data representing the directivity of the sound output from the object, and is transmitted together with the audio data of the object and used for audio reproduction. By doing so, audio reproduction based on the directional characteristic of the object can be performed using the audio data and the directivity data.

The directivity data can be obtained, for example, by recording sound of an object with a plurality of microphones. Note that the recording of the directivity data may be performed simultaneously with the recording of the audio data of the object, or may be performed at a timing different from the recording of the audio data of the object.

The directivity data is prepared for each sound source type such as a voice, a musical instrument, and a speaker. Further, the directivity data is, for example, data having information of the amplitude and the phase of the sound from the sound source for each target frequency in the entire frequency band from the frequency to be DC to the Nyquist frequency for a position in each direction viewed from the sound source.

For example, the direction viewed from the sound source is represented by an angle in the horizontal direction viewed from the sound source position, that is, an azimuth angle, and an angle in the vertical direction viewed from the sound source position, that is, an elevation angle. At this time, for example, the range of the azimuth angle is set to a range of 0 degrees to 360 degrees, and the range of the elevation angle is set to a range of −90 degrees to +90 degrees.

The directivity data obtained by recording includes, for example, gains (hereinafter, referred to as a directional gain) indicating a plurality of discrete directivity characteristics for each frequency at a plurality of positions (hereinafter, referred to as a data point) on the surface of the sphere centered on the sound source position. Note that the directivity data may be data in Higher Order Ambisonics (HOA) format or the like including complex directivity gains for each frequency at each data point.

For example, the position to be the data point can be represented by coordinates (polar coordinates) of a polar coordinate system with the sound source position as the origin, that is, an azimuth angle indicating a position in the horizontal direction viewed from the sound source position and an elevation angle indicating a position in the vertical direction viewed from the sound source position. Note that the distance (radius) from the sound source position may be used to represent the position of the data point. Furthermore, the directivity gain can be obtained by normalizing the amplitude (sound pressure) of the sound from the sound source at the data point.

Various methods are conceivable for transmitting or recording the directivity data defined by the discretized data points on the spherical surface as described above.

Specifically, for example, a non-parametric method of coding and transmitting (recording) directivity data, that is, a directivity gain of each data point as it is can be considered.

In addition, for example, a method of performing parametric modeling that enables continuous representation of directivity data using a distribution such as a vMF (von Mises Fisher) distribution or a Kent distribution on a spherical surface, and transmitting a parameter for restoring the modeled directivity data, and the like can be considered.

Further, a method of transmitting not only the parameter for restoring the modeled directivity data but also the residual between the modeled directivity data and the original directivity data before modeling is also considered.

In a case where it is desired to record (transmit) the directivity data with high accuracy, it is necessary to reduce the angular resolution and the frequency resolution, and thus, the bit rate of the data to be recorded or transmitted increases, and the amount of transmission increases. Therefore, there is a trade-off relationship between accuracy and a transmission amount.

Therefore, for example, it is conceivable to reduce the amount of data to be recorded or transmitted while suppressing the error with the original directivity data to a low level by thinning out the data by utilizing the symmetry of the original directivity data or the like.

The present technology is to reduce the amount of data for transmitting (recording) directivity data by determining data points to be thinned out by a predetermined method such as utilizing symmetry.

Hereinafter, not only a specific method such as thinning but also interpolation processing for restoring thinned data on the decoding side will be specifically described.

### (Data Recording Method)

First, a method of transmitting or recording directivity data will be described. In the following description, it is assumed that the directivity data is transmitted. However, even in a case where the directivity data is recorded, the recording can be performed by a similar method.

For example, it is assumed here that the directivity data is recorded (described) and transmitted by any one of a non-parametric method, a hybrid recording method, and a prediction coding method described below.

### (Recording Method (1): Non-Parametric Method)

In the non-parametric method, the original directivity data, that is, the value of the original directional gain at each data point is directly coded by a predetermined method such as arithmetic coding, and the resultant data is stored in the bit stream and transmitted. Hereinafter, the coded directivity gain is also particularly referred to as a coding directivity gain.

### (Recording Method (2): Hybrid Recording Method)

In the hybrid recording method, first, the original directivity data is modeled.

For example, a mixture model including at least one of a VMF distribution and a Kent distribution on a spherical surface is used for modeling.

Note that the vMF distribution, the Kent distribution, and the mixture model are described in detail in, for example, “John T. Kent (1982). The Fisher-Bingham Distribution on the Sphere”.

In the present technology, the directivity data on the spherical surface, that is, the shape (distribution) of the directivity gain is modeled using the mixture model of the vMF distribution and the Kent distribution corresponding to the Gaussian distribution defined on the spherical surface.

The mixture model may include one or a plurality of vMF distributions, one or a plurality of Kent distributions, or one or a plurality of vMF distributions and one or a plurality of Kent distributions. That is, the mixture model includes one or a plurality of distributions including at least one of the vMF distribution and the Kent distribution. Note that the mixture model may be expressed by any distribution such as a complex Bingham distribution or a complex watson distribution.

When the directivity data is modeled, and as a result, a mixture model that is the directivity data after modeling is obtained, a difference between the mixture model and the original directivity data before modeling is obtained as residual data. That is, the residual data is obtained by subtracting the value of the mixture model from the original directivity data (directivity gain) for each data point.

Then, the residual data of each data point is coded by a predetermined method such as arithmetic coding similarly to the non-parametric method described above, and the coded residual data obtained as a result and the model parameter which is a parameter for restoring the mixture model are transmitted.

The hybrid recording method is a method in which a modeling method for modeling and transmitting directivity data and the above-described non-parametric method are combined.

### (Recording Method (3): Predictive Coding Method)

The prediction coding method is a method of reducing a data transmission amount by calculating a difference between a prediction result of data to be transmitted (recorded) and actual data and transmitting the difference as prediction residual data.

For example, the data to be the calculation target of the prediction residual data may be the original directivity data or the residual data that is the difference between the directivity data before and after the modeling.

As a specific example, a case where prediction residual data is calculated for residual data and the prediction residual data is transmitted will be described below.

Now, the directivity data at a predetermined data point (hereinafter, also referred to as a data point n) indicated by the index n, that is, the directivity gain is described as y (n). Further, a directivity gain at the data point n of the mixture model (modeled data) obtained by modeling the directivity data is denoted as y′ (n).

In this case, the residual x (n) at the data point n, that is, the residual data that is the difference between the directivity gain y (n) and the directivity gain y′ (n), can be obtained by Formula (1) below.

$$\begin{matrix}[ Math . 1 ] & \\ x ( n ) = y ( n ) - {y}^{′} ( n ) & ( 1 )\end{matrix}$$

In addition, if linear prediction or the like is performed on the basis of the residual x (n−i) at another data point (n−i) (where i=1, 2, . . . , p) in the vicinity of the data point n, the prediction value x′ (n) of the residual x (n) of the data point n can be obtained.

For example, the prediction value x′ (n) can be obtained by calculation of Formula (2) below on the bases of the residual x (n−i) at each of the p data points (n−i) and a prediction coefficient aᵢ that is a predetermined weight for those data points (n−i).

$$\begin{matrix}[ Math . 2 ] & \\ {x}^{′} ( n ) = {\sum }_{i = 1}^{p} {a}_{i} x ( n - i ) & ( 2 )\end{matrix}$$

Note that, as the residual x (n−i) of the data point (n−i) in Formula (2), a prediction value x′ (n−i) already obtained by calculation similar to Formula (2) is used. In other words, Formula (2) is calculated using the prediction value x′ (n−i) already obtained by calculation as the residual x (n−i).

In Formula (2), linear prediction is performed using a prediction value (residual) at a neighboring data point. Note that the method of calculating the prediction value x′ (n) is not limited to linear prediction, and any other prediction method may be used.

When the prediction value x′ (n) of the residual x (n) at the data point is obtained, the difference between the prediction value x′ (n) and the actual residual x (n) is obtained as the prediction residual (prediction residual data). Specifically, the prediction residual can be obtained by calculation of Formula (3) below.

$$\begin{matrix}[ Math . 3 ] & \\ Prediction residual = x ( n ) - {x}^{′} ( n ) & ( 3 )\end{matrix}$$

When the prediction residual data is obtained for each data point, the prediction residual data is appropriately coded by a predetermined method such as arithmetic coding, and the coded prediction residual data obtained as a result and the model parameter for restoring the mixture model are transmitted. In this case, the prediction coefficient ai used for prediction calculation (prediction computation) of the residual x (n) and the like are also transmitted as necessary.

Note that, in a case where the data to be the calculation target of the prediction residual data is the original directivity data, that is, the directivity gain, the value of the directivity gain (directivity data) is obtained as the prediction value for each data point. Then, a difference between the prediction value and the original directional gain is obtained as prediction residual data.

Furthermore, for example, the prediction coding method may be selected only in a case where the prediction residual (prediction residual data) has a smaller dynamic range than the residual data (residual x (n)) and the data amount after coding is also small. In this case, when the dynamic range of the prediction residual is larger than the dynamic range of the residual data, or when the data amount after coding of the prediction residual is larger than the data amount after coding of the residual data, the hybrid recording method may be selected instead of the prediction coding method.

### (Data Thinning Method)

As described above, in the present technology, any one of the non-parametric method, the hybrid recording method, and the prediction coding method described above is selected as the recording method of the directivity data, and the data for each data point is generated from the directivity data according to the selected recording method.

Here, the data for each data point is data related to the directivity of the sound source to be determined whether to be thinned out or recorded.

Specifically, the data for each data point is a directional gain in the non-parametric method, residual data in the hybrid recording method, and prediction residual data in the prediction coding method. Hereinafter, the data for each data point is also particularly referred to as recording target data.

In addition, data is generated for each data point according to the selected recording method, but if data of all data points is transmitted, the amount of data transmission, that is, the bit rate of data increases.

Therefore, in the present technology, data points are appropriately thinned out, that is, data is thinned out for each data point, and the amount of data transmission is reduced.

In a case where data points arranged at a high density are thinned out, if an index of a thinned data point or an index of a data point remaining without being thinned out is described in a bit stream, it is considered that the bit rate increases conversely in many cases.

Therefore, it is conceivable that fewer parameters are described in a bit stream (syntax), data points not thinned out on the coding side are specified on the decoding side, and for example, thinned data points can be uniquely restored on the decoding side.

In the present technology, as a data thinning method, any one of a fixed point designation method, a target data modeling method, a hybrid thinning method, and a symmetry using method described below is appropriately selected, and data points are thinned out by the selected method.

Note that, in the following description, among the data points arranged on the spherical surface, a data point at which data is recorded in the bit stream without being thinned out is also particularly referred to as a recording data point. In addition, hereinafter, among the data points, a data point at which data is thinned out and is not recorded in the bit stream is also particularly referred to as a thinning data point.

### (Thinning Method (1): Fixed Point Designation Method)

In the fixed point designation method, a plurality of profiles, which are information defining a data point desired to be recorded, that is, a set of data points to be recording data points, is prepared in advance.

Then, a profile flag for specifying which profile is designated among a plurality of profiles prepared in advance is stored in the bit stream and transmitted.

That is, in the fixed point designation method, on the decoding side, a profile flag for specifying a profile is transmitted to the decoding side as recording point restoration information that is information for specifying a data point set as a recording data point.

Each profile is information indicating a set of one or a plurality of predetermined recording data points. The profile flag is profile information indicating any of a plurality of profiles having different arrangement of recording data points.

For example, the selected profile can be uniquely specified by the value of the profile flag, and by switching the value of the profile flag, the data of which data point is recorded can be transmitted without recording the index information of the actual data point.

In this case, the decoding side can specify the profile selected on the coding side from the value of the profile flag. Therefore, from the selected profile, the recording data point defined by the profile can be specified. For example, the value of the profile flag is a value of a profile ID indicating the selected profile.

Note that, in each profile, an arbitrary data point can be designated as a recording data point, and when the profile is specified, the position of the data point to be the recording data point designated in the profile is uniquely designated.

For example, in the predetermined profile 1, it is conceivable that a front direction is emphasized for audibility, and data (recording target data) is recorded using a data point in a region in a range in which an azimuth angle is +45 degrees and an elevation angle is +30 degrees from a median plane viewed from a sound source as a recording data point without performing thinning. In this case, it is conceivable that data (recording target data) is not recorded as a thinning data point at a data point outside the above region.

Furthermore, for example, in the profile 2, it is conceivable that recording data points are arranged at equal intervals so that omnidirectional data is uniformly recorded.

In the fixed point designation method, a profile is determined (selected) on the coding side, and a data point defined in the profile is set as a recording data point. Then, only the data (recording target data) of the recording data point among the data points is described in the bit stream, and the data of the data point (thinning data point) that has not been set as the recording data point is not described in the bit stream. That is, the data of the thinning data points is thinned out.

On the other hand, on the decoding side, the profile designated on the coding side is specified on the basis of the value of the profile flag extracted from the bit stream. Then, information such as the recording data point, more specifically, the coordinates of the recording data point can be restored from the profile specification result, and the recording data point is associated with the recording target data stored in the bit stream. That is, each recording target data is allocated to an appropriate recording data point, and the recording data point is associated with the recording target data at the recording data point.

### (Thinning Method (2): Target Data Modeling Method)

In the target data modeling method, for example, data points are thinned out, in other words, recording data points are designated for each of a plurality of regions on a spherical surface.

For example, when determining (selecting) the recording data point or the thinning data point, it is conceivable to selectively set a data point in a region where the recording target data is large or a region where the variation of the recording target data is large as the recording data point and record the recording target data.

Here, the region where the variation of the recording target data is large is a region where the gradient of the value of the recording target data on the spherical surface, that is, for example, the first derivative (difference) of the recording target data is large.

In the target data modeling method, data points are thinned out on the basis of at least one of the value itself of the recording target data, that is, the size of the recording target data and the inclination (gradient) of the recording target data.

The target data modeling method is applicable to any of a non-parametric method, a hybrid recording method, and a prediction coding method as a recording method.

In the target data modeling method, modeling target data based on recording target data is calculated for each data point.

The modeling target data is data used to determine a recording data point or a thinning data point, and is calculated on the basis of at least one of a value (size) of the recording target data and a gradient (difference) of the recording target data.

For example, in a case where only the value (size) of the recording target data is used, the recording target data of each data point is used as the modeling target data of each data point as it is.

Similarly, in a case where only the gradient of the recording target data is used, the gradient of the recording target data at each data point is set as the modeling target data at each data point.

In this case, for example, a difference between recording target data of a data point and recording target data of another data point adjacent to the data point is obtained for each data point, and the obtained difference is set as a gradient (value of modeling target data) at the data point. At the time of calculating the difference, preprocessing such as taking the sum of differences in a plurality of directions, taking an absolute value (not distinguishing positive and negative of the gradient), excluding a difference value equal to or less than a predetermined value by a threshold, and performing scale conversion (for example, applying an exponential function) may be applied.

In a case where both the value (magnitude) and the gradient (difference) of the recording target data are used, the value of the recording target data at the data point and the gradient of the recording target data are weighted and added, and the value obtained as a result is set as the value of the modeling target data at the data point.

When modeling target data at each data point on the spherical surface, in other words, modeling target data including values at each data point on the entire spherical surface is obtained, the region of the entire spherical surface is divided on the basis of the modeling target data. That is, region designation (region division) is performed on the basis of the modeling target data.

Then, recording data points and thinning data points are selected according to the result of such region designation. For example, recording target data of data points in a specific region can be recorded, and recording target data of data points outside the specific region can be thinned out (not recorded).

In the target data modeling method, several methods can be considered as a specific method of determining (selecting) the recording data points and the thinning data points on the basis of the modeling target data.

Here, three methods of a threshold processing method, a discretization method, and a modulation method will be described as examples of a specific method (recording data point selection method) for determining the recording data points and the thinning data points on the basis of the modeling target data.

### (Recording Data Point Selection Method (1) in Target Data Modeling Method: Threshold Processing Method)

In the threshold processing method, modeling of the modeling target data described above, more specifically, modeling of data including the modeling target data of each data point is performed.

Specifically, for example, the modeling target data is modeled using a mixture model including one or a plurality of distributions including at least one of the vMF distribution and the Kent distribution. Note that the mixture model is not limited to the vMF distribution and the Kent distribution, and may be configured (expressed) by any distribution such as a complex Bingham distribution and a complex watson distribution.

When the position vector indicating the position of the spherical surface, that is, the coordinates of the orthogonal coordinate system (Cartesian coordinate system) is x, the value f (x) of the Kent distribution corresponding to the position vector x, that is, the value f (x) of the Kent distribution at the position indicated by the position vector x can be expressed by Formula (4) below.

$$\begin{matrix}[ Math . 4 ] & \\ f ( x ) = \frac{1}{c ( κ , β )} exp \{ {κγ}_{1}^{⊤} \cdot x + β [ {( {γ}_{2}^{⊤} \cdot x )}^{2} - {( {γ}_{3}^{⊤} \cdot x )}^{2} ] \} & ( 4 )\end{matrix}$$

Note that, in Formula (4), k represents the parameter concentration degree, and β represents the ellipticity. In addition, γ₁ represents a vector (mean vector) defining the center of the mean direction distribution, γ₂ represents a major axis vector, and γ₃ represents a minor axis vector.

Further, c (κ, β) is a normalization constant expressed by Formula (5) below. Note that, in Formula (5), Γ represents a gamma function, and I represents a modified Bessel function of the first kind.

$$\begin{matrix}[ Math . 5 ] & \\ c ( κ , β ) = 2 π {\sum }_{j = 0}^{∞} \frac{⌈ ( j + \frac{1}{2} )}{⌈ ( j + 1 )} {{β}^{2 j} ( \frac{1}{2} κ )}^{- 2 j - \frac{1}{2}} {I}_{2 j + \frac{1}{2}} ( κ ) & ( 5 )\end{matrix}$$

In addition, the value of the vMF distribution at the position indicated by the position vector x can also be expressed by the similar formula as Formula (4). In this case, there is no term multiplied by β in Formula (4) (0).

In the threshold processing method, modeling target data is represented (modeled) using a mixture model obtained by mixing the vMF distribution and the Kent distribution.

For example, the output value F (x, Θ) of the mixture model using N Kent distributions f (x; θᵢ) at the position indicated by the position vector x similar to the case in Formula (4) can be expressed by Formula (6) below. That is, the mixture model F (x; Θ) can be expressed by weighted addition of the N Kent distributions f (x; θᵢ).

$$\begin{matrix}[ Math . 6 ] & \\ F ( x ; Θ ) = {\sum }_{i = 1}^{N} {∅}_{i} f ( x ; {θ}_{i} ) & ( 6 )\end{matrix}$$

Note that, in Formula (6), the Kent distribution f (x; θᵢ) is similar to that shown in Formula (4) described above, and indicates the i-th Kent distribution among the N Kent distributions to be mixed.

Further, θᵢ is a parameter constituting the Kent distribution f (x; θᵢ), more specifically, a set of parameters, and the parameter θᵢ includes a parameter concentration degree κ in Formula (4), an ellipticity β, a vector γ₁, a major axis vector γ₂, and a minor axis vector γ₃. The parameter Θ of the mixture model F (x; Θ) represents a set of the parameters θᵢ of the N Kent distributions f (x; θᵢ).

Further, in Formula (6), φᵢ represents a weight (weighting coefficient) of an i-th Kent distribution f (x; θᵢ) when the N Kent distributions are mixed, and the sum of the weight φᵢ of the N Kent distributions f (x; θᵢ) is 1 as shown in Formula (7) below.

$$\begin{matrix}[ Math . 7 ] & \\ {\sum }_{i = 1}^{N} {∅}_{i} = 1 & ( 7 )\end{matrix}$$

When the modeling target data is modeled, a value at each position (data point) of the mixture model representing the modeling target data after the modeling is compared with a predetermined threshold Threshold. That is, threshold processing using the threshold Threshold is performed on the value at each position of the mixture model.

Then, for example, a data point at which the value of the modeling target data after modeling is equal to or larger than the threshold Threshold value is set as a recording data point, and a data point at which the value is less than the threshold Threshold value is set as a thinning data point.

Note that, for example, a data point at which the value of the modeling target data after modeling is equal to or less than the threshold Threshold value may be set as the recording data point, and a data point at which the value is larger than the threshold Threshold value may be set as the thinning data point.

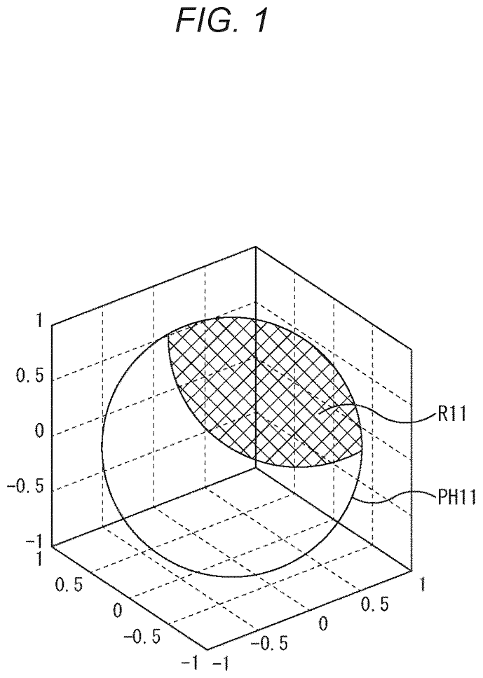

As illustrated in FIG. 1, it is assumed that modeling target data after modeling is represented by a mixture model representing a distribution on the surface of the sphere PH11 centered on the sound source position.

In addition, it is assumed that, as a result of performing threshold processing on the value at each position (data point) of the mixture model, it is determined that the value is equal to or larger than the threshold Threshold in the region R11 on the surface of the sphere PH11. That is, it is assumed that the value is equal to or larger than the threshold Threshold at each data point in the region R11, and the value is less than the threshold Threshold at each data point outside the region R11.

In this case, for example, each data point in the region R11 is set as a recording data point, and each data point outside the region R11 is set as a thinning data point.

In this example, the data points having a large value of the modeling target data are unevenly distributed in the region R11, and the region R11 is designated as the region including the recording data points, that is, the recording range by the threshold processing.

Note that, here, an example has been described in which the threshold processing by the threshold Threshold is performed on the mixture model, however, as the threshold processing, comparison with the threshold may be performed for each distribution such as the vMF distribution and the Kent distribution constituting the mixture model. That is, the threshold processing may be performed for each distribution constituting the mixture model. In such a case, the threshold Threshold may be determined for each distribution, or a common threshold Threshold may be determined for the entire distribution.

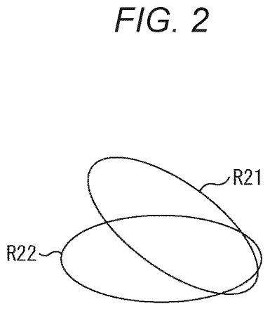

For example, it is assumed that the mixture model includes two distributions, and a result illustrated in FIG. 2 is obtained as a result of comparing each of the distributions with a threshold value.

In the example of FIG. 2, the region R21 represents a region in which a value of one distribution is equal to or larger than the threshold Threshold in the one distribution constituting the mixture model. Similarly, the region R22 represents a region where the value of the distribution is equal to or larger than the threshold Threshold in the other distribution constituting the mixture model.

In this case, the region including the recording data points, that is, the recording range is designated by the set of the region R21 and the region R22.

Specifically, a data point in at least one of the region R21 and the region R22 is set as a recording data point, and a data point not in any of the region R21 and the region R22 is set as a thinning data point.

In the target data modeling method, on the decoding side, recording region specifying information for specifying a recording range (recording region) including recording data points is transmitted to the decoding side as recording point restoration information for specifying a data point serving as a recording data point.

In particular, in the threshold processing method of the target data modeling method, the model parameter for restoring the mixture model that is the modeling target data after modeling and the threshold Threshold are transmitted to the decoding side as the recording region specifying information. Note that, in a case where the threshold Threshold is known on the decoding side, the threshold Threshold may not be transmitted.

For example, in a case where the mixture model is configured by the vMF distribution or the Kent distribution, a weight φᵢ, a parameter concentration degree κ, an ellipticity β, a vector γ₁ which is a mean vector, a major axis vector γ₂, and a minor axis vector γ₃ are transmitted as model parameters.

Among these parameters, the ellipticity β, the major axis vector γ2, and the minor axis vector γ₃ are for restoring the Kent distribution. Therefore, in a case where there is no Kent distribution in the distribution constituting the mixture model, that is, in a case where the mixture model includes only the vMF distribution, the model parameters do not include the ellipticity β, the major axis vector γ₂, and the minor axis vector γ₃.

### (Recording Data Point Selection Method (2) in Target Data Modeling Method: Discretization Method)

In the discretization method, similarly to the case of the threshold processing method, the modeling target data is modeled using the mixture model.

Here, modeling is performed using the mixture model including the vMF distribution and the Kent distribution, and the mixture model F (x; Θ) has been obtained as modeling target data after modeling, that is, modeling target data that has been modeled.

In this case, according to the inclination F′ (x; Θ) of the mixture model F (x; Θ) or the mixture model F (x; Θ), sparseness and denseness of the recording data point are determined. As an example, for example, in the case of one mixture, that is, in the case of the mixture model F (x; Θ) includes one distribution, the recording data points are made sparse with increasing distance from the median vector designated by γ₁.

In the discretization method, for example, a value at each position of the mixture model F (x; Θ) is quantized according to a range with a predetermined step value, that is, a step width. Then, by selecting data belonging to each quantized data value, spatially unequal sampling is performed, and data points to be actually recorded are determined.

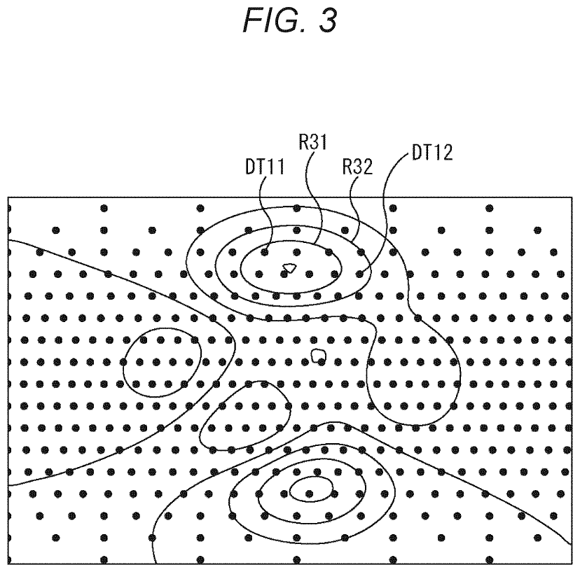

Specifically, for example, it is assumed that data points are arranged on a spherical surface as illustrated in FIG. 3. Note that FIG. 3 illustrates a state in which the distribution on the spherical surface expressed by the mixture model is developed on a plane. Further, in FIG. 3, each point represents a data point, and each position has a value of the mixture model.

In this example, for example, the value of the mixture model is discretized by a predetermined step width such as 0.5, and a region surrounded by one curve represents a region where the discretized value is the same value.

For example, in a case where the step width is 0.5, the region of the entire spherical surface is discretized (divided) into regions according to the quantized data value determined by the step width, such as a region including a position having a value in a range of 0.0 to 0.5 dB and a region including a position having a value in a range of 0.5 to 1.0 dB.

For example, one region R31 is one region having the same value after discretization of the mixture model, and this region R31 includes a plurality of data points including the data point DT11. Similarly, the region R32 surrounding the outside of the region R31 is also one region having the same value after discretization of the mixture model, and the region R32 includes a plurality of data points including the data point DT12.

In the discretization method, for example, for each region after discretization, one or a plurality of data points belonging to the region are selected (determined) as recording data points. For example, some data points in the region R31 are selected as recording data points, while some data points in the region R32 are also selected as recording data points.

Hereinafter, a range of values of the mixture model in which values after discretization determined by the step width have the same value is also referred to as a discretization range, and a value after discretization of values belonging to the discretization range is also referred to as a quantized data value. Furthermore, hereinafter, a region including positions where values after discretization (after quantization) are the same, that is, a region including positions having the same quantized data value is also referred to as a discretization region.

Therefore, at the time of discretization of the mixture model, which discretization range the value of the predetermined position belongs to is specified, and the quantized data value determined for the specified discretization range is set as the value after discretization of the predetermined position.

As a specific example, for example, in a case where the step width is 0.5, if the value at a predetermined data point of the original mixture model is 0.1 dB, the data point belongs to a discretization range in which the value range is 0.0 to 0.5 dB. In addition, if the quantized data value determined for the discretization range of 0.0 to 0.5 dB is 0.0 dB, the value after discretization of the data point whose value before discretization of the mixture model is 0.1 dB is 0.0 dB. In the example illustrated in FIG. 3, the region R31 and the region R32 are one discretization region.

For example, on the basis of a value at each data point in the mixture model, recording data points and thinning data points are determined by a combination of predetermined criteria described below. In other words, among the data points included in the discretization region, one or a plurality of data points satisfying a specific condition is set as recording data points.

As an example of the predetermined criterion, it is conceivable to select a data point in the vicinity of the vector γ₁ (mean vector) of the mixture model including the vMF distribution and the Kent distribution, for example, at a position closest to the vector γ₁, as the recording data point. Furthermore, as another example of the predetermined standard, in a case where there is a plurality of data points included in each region (discretization region) after discretization of the entire spherical surface of the mixture model, it is conceivable to determine (select) the recording data points as follows.

That is, it is conceivable that at least one data point having a value closest to the median value of the discretization range is selected according to the discretized situation, and the selected data point is set as the recording data point. At this time, in a case where there is only one data point included in the discretization region, the one data point is only need to set as the recording data point.

Note that, in a case where there is a plurality of data points included in the discretization region, one or a plurality of data points having the largest value before discretization or one or a plurality of data points having the smallest value before discretization may be selected, and the selected data points may be set as recording data points.

In addition, for example, as another example of the predetermined criterion, in a case where recording data points are additionally selected, it is also conceivable that a predetermined number of data points in the direction of each of a plurality of orientations centered on the vector γ₁ (mean vector) of the mixture model are selected as the recording data points. In addition, the recording data points may be selected such that the variance of the set of recording data points is maximized.

When the recording data point is selected as described above, for example, in a case where the size of the recording target data is used as the modeling target data as it is, a data point having large or small recording target data can be preferentially selected as the recording data point. This can be realized by selecting more recording data points as the discretization region has a larger or smaller quantized data value.

Similarly, for example, in a case where the gradient of the recording target data is set as the modeling target data, a data point where the variation of the recording target data is severe, that is, a data point where a difference (gradient) between adjacent positions is large can be preferentially selected as the recording data point.

In the discretization method of the target data modeling method, as the recording region specifying information, the model parameter for restoring the mixture model that is the modeling target data after modeling and the step width for discretizing the mixture model are transmitted to the decoding side. Note that, in a case where the step width is known on the decoding side, the step width may not be transmitted.

For example, in a case where the mixture model is configured by the vMF distribution or the Kent distribution, a weight φᵢ, a parameter concentration degree κ, an ellipticity β, a vector γ₁ which is a mean vector, a major axis vector γ₂, and a minor axis vector γ₃ are transmitted as model parameters.

Note that, similarly to the case of the threshold processing method, the ellipticity β, the major axis vector γ₂, and the minor axis vector γ₃ are transmitted only in a case where the distribution constituting the mixture model has the Kent distribution.

In addition, for example, the threshold Threshold similar to that in the case of the threshold processing method may be used for the discretization region or the like in selecting the recording data point. In such a case, the threshold Threshold is defined for the entire mixture model, or the threshold Threshold is defined for each distribution (mixture) constituting the mixture model. Then, the threshold Threshold defined in the recording region specifying information is included.

### (Recording Data Point Selection Method (3) in Target Data Modeling Method: Modulation Method)

In the modulation method, modulation is utilized to achieve sparseness and denseness of recording data points across a spherical surface.

In the discretization method described above, the recording data points are determined by discretizing the mixture model, but in the modulation method, amplitude modulation (AM) modulation is performed on the mixture model, and the recording data points are selected on the basis of the modulation result.

In the modulation method, similarly to the case of the discretization method and the threshold processing method, the modeling target data is modeled using the mixture model.

Here, it is assumed that modeling is performed using a mixture model including a vMF distribution and a Kent distribution, and the mixture model is obtained as modeling target data after modeling.

Next, AM modulation is performed on the mixture model using a frequency modulation (FM)-modulated carrier signal, and the recording data point is selected on the basis of the output (hereinafter, also referred to as a modulation model) obtained as a result, the coordinates of the existing data point, and a predetermined threshold.

In order to simplify the description, an example in which the mixture model includes one vMF distribution will be described.

For example, the vMF distribution as a mixture model is expressed by Formula (8) below similarly to the case of Formula (4) described above.

$$\begin{matrix}[ Math . 8 ] & \\ f ( X ) = \frac{1}{c ( κ )} exp \{ {κγ}_{1}^{⊤} \cdot x \} & ( 8 )\end{matrix}$$

In Formula (8), f (x) represents the value of the vMF distribution at the position indicated by the position vector x.

In addition, c (κ) in Formula (8) is a normalization constant expressed by Formula (9) below.

$$\begin{matrix}[ Math . 9 ] & \\ c ( κ ) = \frac{{( 2 π )}^{3 / 2} {I}_{3 / 2 - 1} ( κ )}{{κ}^{3 / 2 - 1}} & ( 9 )\end{matrix}$$

When AM modulation is performed on f (x) that is such a vMF distribution, a distribution f′ (x) after AM modulation, that is, a modulation model is expressed by Formula (10) below.

$$\begin{matrix}[ Math . 10 ] & \\ {f}^{′} ( x ) = cos ( - 2 π f ( d / v - g ( d ) ) ) \frac{1}{c ( κ )} exp \{ {κγ}_{1}^{⊤} \cdot x \} & ( 10 )\end{matrix}$$

Note that, in Formula (10), f represents a modulation frequency (Hz), and v represents a propagation velocity (rad/s) of modulation, that is, a modulation velocity. Furthermore, in Formula (10), d represents an angular distance (rad) from the position of the vector γ₁ (mean vector), and g (d) represents a predetermined function using the angular distance d as an argument.

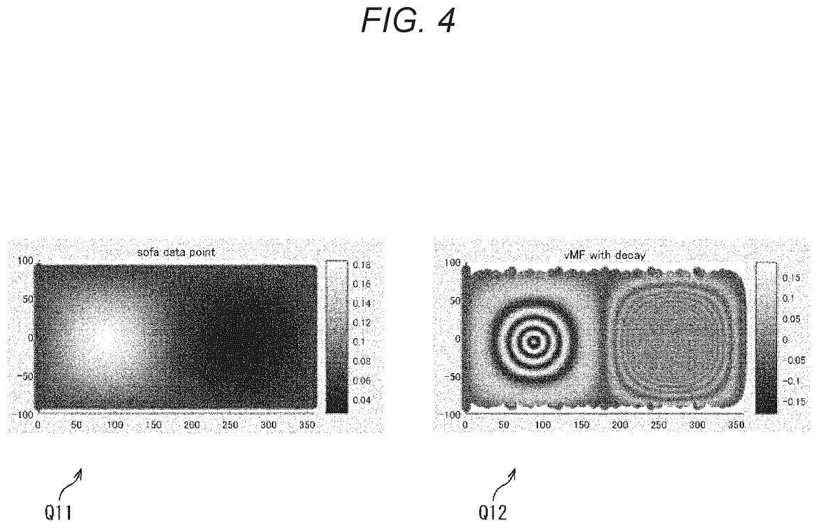

As a specific example, for example, when AM modulation is performed on a vMF distribution (mixture model) indicated by an arrow Q11 in FIG. 4 by calculation of Formula (10), a modulation model indicated by an arrow Q12 is obtained.

Note that, in FIG. 4, the horizontal axis represents the azimuth angle representing the position in the horizontal direction on the spherical surface viewed from the sound source position, and the vertical axis represents the elevation angle representing the position in the vertical direction on the spherical surface viewed from the sound source position. In addition, the color shading in the vMF distribution and the modulation model indicates a value at each position of the model (distribution) before and after modulation.

For example, peaks and valleys in the modulation model, that is, peaks and dips due to shading are characteristic portions such as large modeling target data. Therefore, a data point at a peak or a dip of such a modulation model or a data point in the vicinity of the peak or the dip is a data point to be set as a recording data point.

Therefore, in the modulation method, threshold processing is performed on the basis of a value of a modulation model (modulation vMF mixture model) obtained by AM modulation and a predetermined threshold prepared in advance, and a recording data point is determined. That is, for example, a data point at which a value in the modulation model is equal to or greater than a predetermined first threshold value or equal to or less than a predetermined second threshold value is set as a recording data point, and all other data points that have not been set as recording data points are set as thinning data points.

Note that, here, in order to simplify the description, an example in which the mixture model includes one vMF distribution (an example of one mixture) has been described. However, the present invention is not limited thereto, and for example, the mixture model may include a plurality of vMF distributions, may include one or a plurality of Kent distributions, or may include a vMF distribution and a Kent distribution.

In the modulation method, for example, AM modulation is performed at the modulation frequency f set at each distance where d/v=1. In addition, the function g (d) is a function according to the angular distance d from the position of the vector γ₁ (mean vector), and the speed of frequency modulation is controlled by the function g (d).

For example, in a case where the function g (d) is a linear function, the frequency attenuation is proportional to the angular distance d, and in a case where the function g (d) is a quadratic function, the frequency attenuation is proportional to the square of the angular distance d, and a function type corresponding to a desired attenuation curve may be used.

Which data point among the defined data points is to be thinned out is determined on the basis of the modulation model.

Specifically, for example, it is conceivable that a modulation model, that is, a data point within a predetermined distance range from a peak (mountain) of a modulated wave is set as a recording data point, and other data points are set as thinning data points. In this case, the predetermined distance (hereinafter, also referred to as a range specifying distance) may be determined by the frequency (modulation frequency) of the modulated wave, or may be an arbitrary distance. The range specifying distance for selecting the recording data point is stored in, for example, the recording region specifying information.

Furthermore, for example, it is conceivable that a data point at which the gain calculated by f′ (x), that is, the value of the modulation model is equal to or greater than a predetermined threshold is set as a recording data point, and the other data points are set as thinning data points. In this case, the predetermined threshold (hereinafter, also referred to as a range specifying threshold) may be determined by the frequency (modulation frequency) of the modulated wave, or may be an arbitrary value. The range specifying threshold for selecting the recording data point is stored in, for example, the recording region specifying information.

In the modulation method of the target data modeling method, as the recording region specifying information, the model parameter for restoring the mixture model that is the modeling target data after modeling, the modulation parameter used for AM modulation of the mixture model, and the threshold information for selecting the recording data point are transmitted to the decoding side. However, in a case where the modulation parameter and the threshold information are known on the decoding side, the modulation parameter and the threshold information may not be transmitted.

Note that, similarly to the case of the threshold processing method, the ellipticity β, the major axis vector γ₂, and the minor axis vector γ₃ are transmitted only in a case where the distribution constituting the mixture model has the Kent distribution.

Furthermore, for example, in a case where AM modulation is performed by calculation of Formula (10), parameters related to the function g (d) such as a modulation frequency f, a modulation velocity v, an angular distance d, and a power value for controlling attenuation are transmitted as modulation parameters. Further, the threshold value information is information indicating the above-described range specifying distance or range specifying threshold value.

### (Thinning Method (3): Hybrid Thinning Method)

The hybrid thinning method is a method in which a fixed point designation method and a target data modeling method are used in combination. Note that any two or more thinning methods may be combined to form a hybrid thinning method.

For example, in the hybrid thinning method, a recording data point that is not desired to cause an error due to interpolation or the like and is necessarily desired to be recorded is recorded by the fixed point designation method. That is, the recording data point is designated by the profile flag.

On the other hand, for other data points other than the data point designated by the profile flag, the recording data point is designated by the target data modeling method. That is, the recording data point is designated by the above-described recording region specifying information.

In this case, the entire recording data point can be designated by a set of the profile flag and the recording region specifying information. That is, among all the data points, the data point set as the recording data point by at least one of the profile flag and the recording region specifying information is finally set as the recording data point.

In such a hybrid thinning method, on the decoding side, a profile flag and recording region specifying information are transmitted to the decoding side as recording point restoration information for specifying a data point set as a recording data point.

### (Thinning Method (4): Symmetry Using Method)

In the symmetry using method, the symmetry of the sound source directivity is utilized.

For example, in a case where the shape of the sound source has symmetry, the directivity of the sound source is also often symmetric. Therefore, when the recording target data is transmitted, the amount of recording target data or transmitted can be reduced by not recording or transmitting the recording target data at a data point at which the recording target data is symmetric (the same) with a predetermined data point, that is, a data point having a positional relationship symmetric with the predetermined data point as viewed from the center of symmetry of the recording target data.

The symmetry using method is applicable to, for example, a case where prediction residual data is transmitted as recording target data, that is, a case where directivity data is transmitted by a prediction coding method.

Even in the case of calculating the prediction residual, by calculating the prediction residual data while traversing the data points in the order in which the residuals are symmetric, it is possible to reduce the data amount of the prediction residual data by symmetry or thinning.

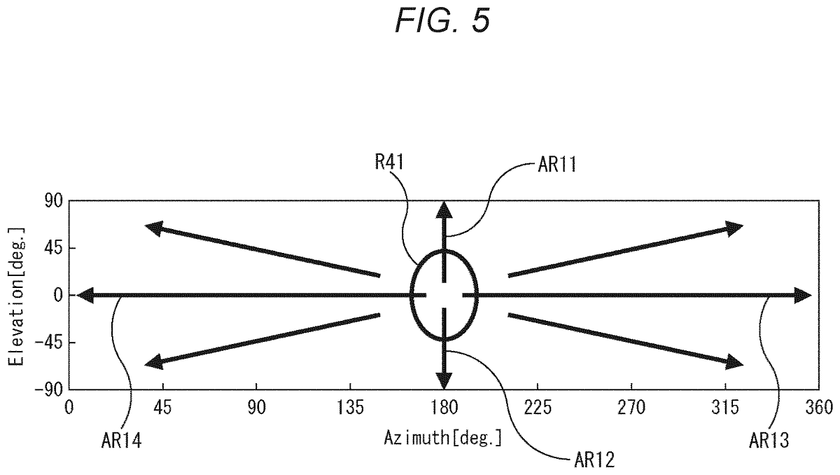

For example, it is assumed that a region on a spherical surface where data points are arranged is developed as illustrated in FIG. 5. Note that, in FIG. 5, the horizontal axis represents the azimuth angle representing the position in the horizontal direction on the spherical surface viewed from the sound source position, and the vertical axis represents the elevation angle representing the position in the vertical direction on the spherical surface viewed from the sound source position.

In this example, it is assumed that a plurality of data points (not illustrated) is arranged on the developed spherical surface, and residual data is obtained for each of the data points.

Furthermore, for example, it is assumed that the data point and the residual data at the data point are bilaterally symmetrical with respect to the position of the center of the region R41, that is, the position of the azimuth angle of 180 degrees. In other words, it is assumed that the positional relationship between the data points and the residual data at the data points are bilaterally symmetrical about the arrows AR11 and AR12.

In this case, the prediction residual at each data point, more specifically, the prediction value x′ (n) of the residual x (n) is calculated in the order of arrangement along each azimuth (direction), such as the arrow AR13 or the arrow AR14, from the center point that is bilaterally symmetrical.

Specifically, for example, the prediction value x′ (n) is obtained by Formula (2) on the basis of the residual x (n−i) at each of p data points (n−i) arranged in the direction indicated by the arrow AR13. At this time, for example, a data point for obtaining the prediction value x′ (n) and a data point (n−i) used for calculating the prediction value x′ (n) are arranged in a direction indicated by the arrow AR13.

In the example of Formula (2), for example, if the prediction value x′ (n) of each data point is obtained in the order of arrangement along the direction indicated by the arrow AR13, the data point for which calculation of the prediction value x′ (n) arranged along the direction indicated by the arrow AR13 has already been performed is used for calculation of the subsequent prediction value x′ (n).

As described above, in the symmetry using method, the prediction value (prediction residual data) of the residual is calculated while selecting (traversing) the data point in the order determined with respect to the type of symmetry of the residual data on the spherical surface, that is, the position of the symmetry center and the axis of symmetry. As a result, in a case where the original residual data is symmetric, the prediction residual data is also symmetric. This makes it possible to utilize symmetry and thinning.

For example, in the symmetry using method, among the prediction residual data of all the data points, a data point having a symmetrical positional relationship with a predetermined data point is set as a thinning data point.

Specifically, for example, in the example of FIG. 5, a straight line passing through the arrow AR11 and the arrow AR12 is the axis of symmetry. Then, a data point on the right side of the symmetry axis in the drawing is a recording data point, and a data point on the left side of the symmetry axis in the drawing is a thinning data point.

In the symmetry using method, as the recording point restoration information for specifying the data point set as the recording data point, the symmetry specifying information, which is information related to the symmetry of the prediction residual data (residual data), is transmitted to the decoding side.

The symmetry characteristic information is information for specifying a center of symmetry, an axis of symmetry, a prediction order that is an order (sequential order) of data points at which a residual is predicted, and the like. Specifically, for example, the symmetry specifying information includes a prediction order ID that can uniquely specify a prediction order, center position information indicating a center position of symmetry, and axis information indicating an axis to be a center of symmetry. For example, the prediction order ID can also be said to be information indicating the order in which the data points used for calculation of prediction of the residual are arranged.

### <Example of Recording Region Specifying Information>

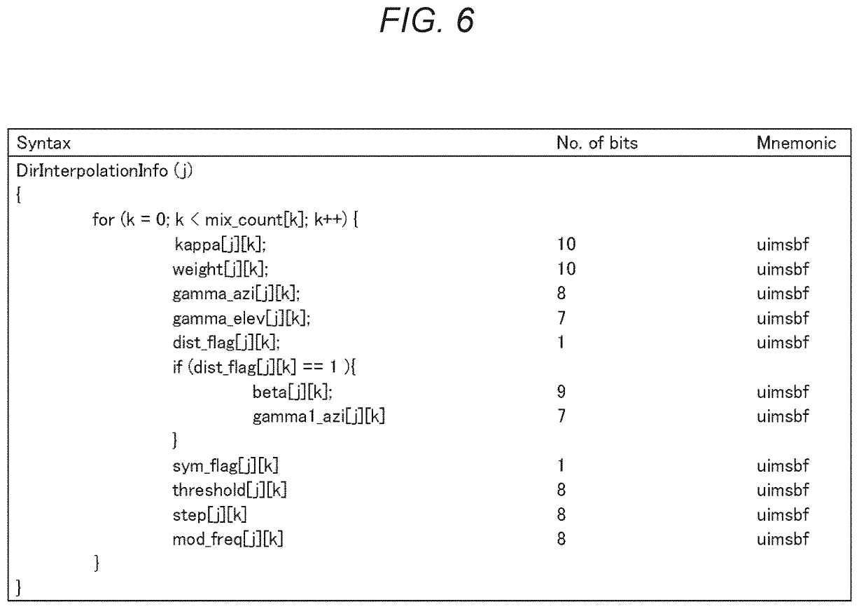

FIG. 6 illustrates a syntax example of the recording region specifying information. Note that FIG. 6 is merely an example, and the recording region specifying information may include at least information necessary for restoring the recording data point according to the recording data point selection method in the target data modeling method selected on the coding side.

In the example illustrated in FIG. 6, the recording region specifying information stores model parameters and the like for each frequency band (frequency bin) j by the number of distributions constituting the mixture model obtained by modeling the modeling target data, that is, the number of mixtures “mix_count [k]”.

Specifically, “kappa [j] [k]”, “weight [j] [k]”, “gamma_azi [j] [k]”, and “gamma_elev [j] [k]” as model parameters, and a selection flag “dist_flag [j] [k]” are stored in the recording region specifying information.

Here, “kappa [j] [k]” indicates the parameter concentration degree K, and “weight [j] [k]” indicates the weight φᵢ.

“gamma_azi [j] [k]” and “gamma_elev [j] [k]” indicate a horizontal direction angle (azimuth angle) and a vertical direction angle (elevation angle) indicating the direction of the mean vector, that is, the vector γ₁. In this example, the vector γ₁ is expressed by the azimuth angle and the elevation angle.

The selection flag “dist_flag [j] [k]” is flag information indicating whether the k-th distribution constituting the mixture model is the Kent distribution or the vMF distribution.

The recording region specifying information also stores “beta [j] [k]” and “gamma1_azi [j] [k]” indicating the ellipticity β as a model parameter according to the value of the selection flag “dist_flag [j] [k]”. In this example, the value “1” of the selection flag “dist_flag [j] [k]” indicates that the k-th distribution is the Kent distribution, and in a case where the k-th distribution is the Kent distribution, “beta [j] [k]” and “gamma1_azi [j] [k]” are stored.

“gamma1_azi [j] [k]” is an angle (rotation angle) in the horizontal direction indicating the relative direction of the major axis vector γ₂ and the minor axis vector γ₃ when viewed from the vector γ₁. That is, in this example, the major axis vector γ₂ and the minor axis vector γ₃ can be obtained from the vector γ₁ and the angle “gamma1_azi [j] [k]”.

The recording region specifying information further stores flag information sym flag [j] [k], threshold information threshold [j] [k], step width step [j] [k], and modulation frequency mod freq [j] [k] for each distribution constituting the mixture model for each frequency (frequency band).

The flag information sym flag [j] [k] is information indicating whether or not to perform an operation such as symmetry or rotation on the target distribution. The threshold information threshold [j] [k] is, for example, a threshold used as the threshold Threshold of the above-described threshold processing method. Note that the threshold information threshold [j] [k] may be used as threshold information indicating a threshold used in the discretization method, a range specifying distance used in the modulation method, or a range specifying threshold.

The step width step [j] [k] indicates a step width used in the discretization method, and the modulation frequency mod freq [j] [k] indicates a modulation frequency as a modulation parameter used in the modulation method.

### <Configuration Example of Server>

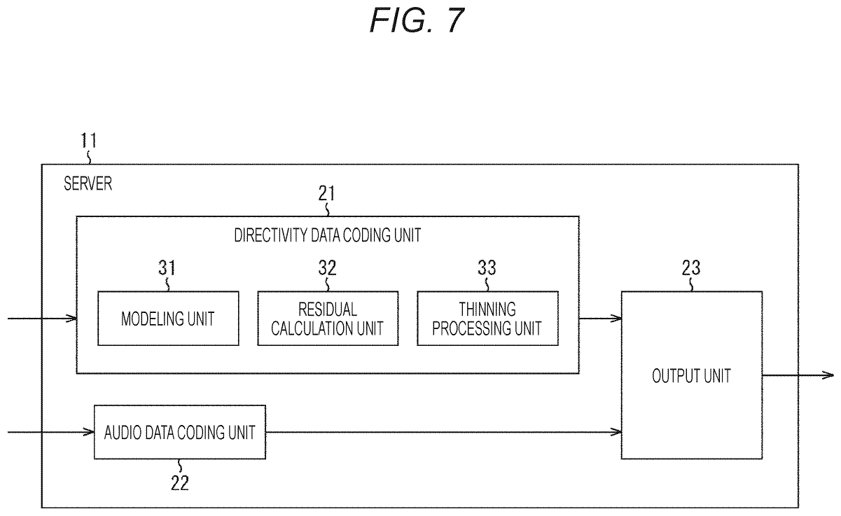

FIG. 7 is a diagram illustrating a configuration example of a server to which the present technology is applied.

A server 11 illustrated in FIG. 7 is an information processing apparatus including, for example, a computer and functions as a coding device that distributes content.

For example, the content includes audio data (object audio data) of one or a plurality of objects and directivity data that is prepared for each sound source type and represents directivity of a sound source (object), that is, a directional characteristic. Note that the content may include video data, tactile data, and the like corresponding to the audio data.

The server 11 includes a directivity data coding unit 21, an audio data coding unit 22, and an output unit 23.

The directivity data including a directivity gain for each frequency (frequency band) is supplied to the directivity data coding unit 21 for each sound source type. The directivity data coding unit 21 selects a recording method or a thinning method for the supplied directivity data, generates coded directivity data according to the selected method, and supplies the coded directivity data to the output unit 23.

The coded directivity data is data obtained by coding directivity data according to the recording method or the thinning method. For example, in a case where the non-parametric method is selected and the data points are not thinned out, data including the coding directivity gain for each frequency at each data point is set as the coding directivity data.

Furthermore, the directivity data coding unit 21 also functions as a generation unit that generates recording point restoration information for each sound source type or for each frequency as necessary and supplies the same to the output unit 23. The arrangement of the recording data points specified by the recording point restoration information differs for each sound source type and for each frequency. That is, the arrangement of the recording data points varies depending on the sound source type and the frequency.

The directivity data coding unit 21 includes a modeling unit 31, a residual calculation unit 32, and a thinning processing unit 33.

The modeling unit 31 models the input directivity data of each sound source type. The residual calculation unit 32 calculates residual data and prediction residual data on the basis of the mixture model obtained by modeling the directivity data and the original directivity data.

The thinning processing unit 33 selects a thinning method, and performs processing of selecting recording data points or thinning data points according to the selection result, that is, processing related to thinning of data points.

The audio data coding unit 22 codes the input audio data of each object, and supplies coded audio data obtained as a result to the output unit 23.

The output unit 23 generates and outputs a coded bit stream by multiplexing the coded directivity data supplied from the directivity data coding unit 21 and the coded audio data supplied from the audio data coding unit 22.

Furthermore, in a case where the recording point restoration information is also supplied from the directivity data coding unit 21, the output unit 23 also multiplexes the recording point restoration information and stores the multiplexed information in the coded bit stream.

Note that, in order to simplify the description, an example in which the coded directivity data and the coded audio data are simultaneously output will be described, but the coded directivity data and the coded audio data may be individually generated and output at different timings. Further, the coded directivity data and the coded audio data may be generated by different devices.

### <Description of Coding Processing>

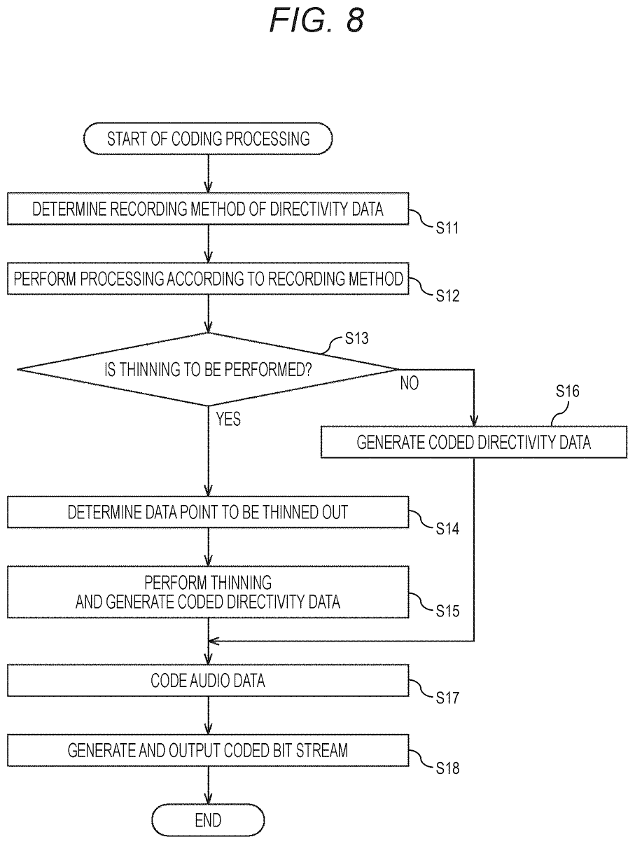

Next, an operation of the server 11 will be described. That is, hereinafter, the coding processing by the server 11 will be described with reference to the flowchart of FIG. 8. In step S11, the directivity data coding unit 21 determines a recording method of the input directivity data of each sound source type.

For example, the directivity data coding unit 21 selects the recording method for each sound source type and frequency on the basis of the frequency of the target directivity data, the sound source type of the directivity data, the selection operation by the input of the creator or the like, and the like. Here, any one of a non-parametric method, a hybrid recording method, and a prediction coding method is selected as the recording method.

For example, which recording method is selected may be determined in advance for each combination of the sound source type and the frequency, or the recording method may be selected by the producer or the like for each combination of the sound source type and the frequency.

In step S12, the directivity data coding unit 21 performs processing according to the recording method selected in step S11 for each frequency on the directivity data of each sound source type.

For example, in a case where a non-parametric method is selected as the recording method for the directivity data, the directivity data coding unit 21 does not particularly perform processing, and sets the directivity data, that is, the directivity gain at each data point as the recording target data as it is.

Furthermore, for example, in a case where a hybrid recording method is selected as a recording method for the directivity data, the modeling unit 31 models the directivity data by representing (expressing) the directivity data with a mixture model including a vMF distribution and a Kent distribution. As a result, parameters such as a parameter concentration degree, a weight, and a vector γ₁ constituting the mixture model are obtained as model parameters.

The residual calculation unit 32 calculates residual data by obtaining a difference between a value at each data point in the mixture model obtained by modeling by the modeling unit 31 and the directivity data before modeling, that is, the directivity gain of each data point. The residual data for each data point thus obtained is set as recording target data.

Furthermore, for example, in a case where the prediction coding method is selected as the recording method for the directivity data, the modeling unit 31 models the directivity data by processing similar to the case of the hybrid recording method.

Furthermore, the residual calculation unit 32 calculates residual data by processing similar to that in the case of the hybrid recording method, and calculates the prediction residual data by performing the above-described calculation of Formula (2) or Formula (3) or the like on the basis of the prediction order and the prediction coefficient determined in advance for each sound source type or the like.

In the prediction coding method, prediction residual data obtained for each data point is set as recording target data. Note that, more specifically, for some data points, not the prediction residual data but the residual data is set as the recording target data.

In step S13, the directivity data coding unit 21 determines whether or not to perform thinning of the recording target data, that is, thinning of the data points.

For example, whether or not to perform thinning is performed for each frequency for each sound source type. In such a case, the subsequent processing in steps S14 and S15 or the processing in step S16 is performed for each frequency for each sound source type.

Specifically, for example, whether or not to perform thinning and which thinning method to perform thinning may be determined for each combination of the sound source type and the frequency, or whether or not to perform thinning may be selected by a creator or the like for each combination of the sound source type and the frequency.

Note that data points may be necessarily thinned out by any thinning method.

In a case where it is determined in step S13 that thinning is to be performed, the directivity data coding unit 21 determines a data point to be thinned out in step S14. In other words, one or a plurality of data points to be recording data points is determined from a plurality of data points arranged on the spherical surface.

For example, the directivity data coding unit 21 selects (determines) a thinning method according to a combination of a sound source type and a frequency, a selection operation of a creator, or the like, and determines (selects) data points to be thinning data points and data points to be recording data points according to the selected thinning method.

In step S15, the directivity data coding unit 21 performs thinning according to the determination in step S14, generates coded directivity data, and supplies the coded directivity data to the output unit 23.

Here, specific examples of steps S14 and S15 will be described.

In a case where the fixed point designation method is selected as the thinning method, the directivity data coding unit 21 selects one of a plurality of profiles prepared in advance.

For example, a profile selected in advance for the combination of the sound source type and the frequency may be determined, or the profile may be selected by a selection operation of a creator or the like. Since data points to be recording data points are determined in advance for each profile, when a profile is selected, the recording data points and the thinning data points are selected (determined).

When the profile is selected, the directivity data coding unit 21 deletes the recording target data of the thinning data points among the recording target data of all the data points. That is, data points other than the recording data points are thinned out.

The directivity data coding unit 21 appropriately codes the recording target data of the recording data points remaining without being thinned out by a predetermined coding method. Note that the coding method may be any coding method such as arithmetic coding or Huffman coding. Similarly, in a case where coding is performed by a predetermined coding method in the following description, the coding method may be any method.

The directivity data coding unit 21 appropriately generates coded directivity data including at least the coded recording target data of each recording data point and generates recording point restoration information including a profile flag indicating the selected profile. Then, the directivity data coding unit 21 supplies the coded directivity data and the recording point restoration information to the output unit 23.

At this time, for example, in a case where the recording method is a non-parametric method, the coded recording target data (directivity gain) of each recording data point, that is, the coding directivity gain is generated as the coding directivity data.

Furthermore, in a case where the recording method is the hybrid recording method, coded directivity data including a model parameter obtained by modeling the directivity data and coded recording target data (residual data) of each recording data point, that is, coded residual data is generated.

Furthermore, in a case where the recording method is the prediction coding method, coded directivity data including model parameters obtained by modeling the directivity data and coded recording target data (prediction residual data) of each recording data point, that is, coded prediction residual data is generated. In this case, the prediction coefficient used to calculate the prediction residual may be included in the coded directivity data or the like, or the prediction coefficient may be known in advance on the coding side and the decoding side.

Furthermore, for example, in a case where the target data modeling method is selected as the thinning method, the directivity data coding unit 21 selects any one of the above-described threshold processing method, discretization method, and modulation method as the recording data point selection method, and determines the recording data points and the thinning data points by the selected method.

In this case, a recording data point selection method selected in advance for the combination of the sound source type and the frequency may be determined, or the recording data point selection method may be selected by a selection operation of a creator or the like.

The directivity data coding unit 21 generates coded directivity data similar to that in the case of the fixed point designation method, and generates recording point restoration information including recording region specifying information according to the selected recording data point selection method of the target data modeling method. Then, the directivity data coding unit 21 supplies the coded directivity data and the recording point restoration information to the output unit 23.

For example, in a case where the threshold processing method is selected, the recording region specifying information including at least the model parameter of the modeling target data and the threshold Threshold is generated.

Further, for example, in a case where the discretization method is selected, the recording region specifying information including at least the model parameter of the modeling target data and the step width for discretizing the mixture model representing the modeling target data is generated.

For example, in a case where the modulation method is selected, the recording region specifying information including at least the model parameter of the modeling target data, the modulation parameter used for AM modulation of the mixture model representing the modeling target data, and the threshold information for selecting the recording data point is generated.

Furthermore, for example, in a case where the hybrid thinning method is selected, the directivity data coding unit 21 performs processing similar to the case of the fixed point designation method described above and processing similar to the case of the target data modeling method.

The directivity data coding unit 21 generates coded directivity data similar to that in the case of the fixed point designation method and recording point restoration information including the profile flag and the recording region specifying information, and supplies the coded directivity data and the recording point restoration information to the output unit 23.

For example, in a case where the symmetry using method is selected as the thinning method, in step S12, the prediction residual data is calculated on the basis of the predetermined prediction order and the prediction coefficient by the prediction coding method. In this case, the nature of the symmetry of the prediction residual data, that is, the kind (type) of the symmetry, such as the left-right symmetry, the top-bottom symmetry, the center of the symmetry, and the axis of the symmetry, is specified by the determination of the prediction order.

The directivity data coding unit 21 determines the recording data points and the thinning data points according to the symmetric property determined from the prediction order and the like.

Specifically, for example, in a case where the prediction residual data is bilaterally symmetric, the directivity data coding unit 21 sets a data point in a right-half region with respect to a symmetric axis as a recording data point, and sets a data point in a left-half region with respect to the symmetric axis as a thinning data point. Then, the prediction residual data of the data point selected as the thinning data point is deleted.

The directivity data coding unit 21 generates coded directivity data similar to that in the case of the fixed point designation method, generates recording point restoration information including the symmetry specifying information, and supplies the coded directivity data and the recording point restoration information to the output unit 23. In this case, the symmetry specifying information is information including, for example, a prediction order ID, center position information indicating a center position of symmetry, and axis information indicating an axis to be a center of symmetry.

After the processing of step S15 is performed, the processing proceeds to step S17.

On the other hand, in a case where it is determined in step S13 that thinning is not performed, the directivity data coding unit 21 generates coded directivity data without performing thinning and supplies the coded directivity data to the output unit 23 in step S16.

For example, in step S16, coded directivity data similar to that in step S15 is generated. However, while the coded directivity data not including the data of the thinning data points is generated in step S15, the coded directivity data including the data of all the data points is generated in step S16.

After the processing of step S15 or step S16 is performed, the processing of step S17 is performed.

That is, in step S17, the audio data coding unit 22 codes the input audio data of each object, and supplies the coded audio data obtained as a result to the output unit 23.

Note that, when there is metadata for the audio data of each object, the audio data coding unit 22 also codes the metadata of each object (audio data), and supplies the coded metadata obtained as a result to the output unit 23.

For example, the metadata includes object position information indicating the absolute position of the object in the three-dimensional space, object direction information indicating the orientation of the object in the three-dimensional space, sound source type information indicating the type of the object (sound source), priority information indicating the priority of the object, spread information indicating the degree of spread of the object, and the like. In addition, data other than those described above may be included in the metadata.

In step S18, the output unit 23 multiplexes the coded directivity data supplied from the directivity data coding unit 21 and the coded audio data supplied from the audio data coding unit 22 to generate and output a coded bit stream.

Note that, in a case where the recording point restoration information is supplied from the directivity data coding unit 21, a coded bit stream including the recording point restoration information is generated. Similarly, when there is metadata in an object, a coded bit stream including coded metadata is generated.

The recording point restoration information is information different from ID information for uniquely identifying the data point serving as the recording data point, that is, information different from an index indicating the data point. Therefore, as compared with a case where such an index for each recording data point is transmitted to the decoding side, the amount of data transmission can be reduced by transmitting the recording point restoration information.

In addition, for example, recording method information indicating the selected recording method or thinning method information indicating the selected thinning method may be generated by the directivity data coding unit 21 and supplied to the output unit 23. In such a case, the output unit 23 also stores the recording method information and the thinning method information in the coded bit stream.

The output unit 23 transmits the coded bit stream to an information processing apparatus functioning as a client (not illustrated). The coded bit stream transmitted in this manner includes recording target data at the recording data point among the plurality of data points arranged on the spherical surface for each sound source type and frequency.

When the coded bit stream is transmitted, the coding processing ends.

As described above, the server 11 generates the coded directivity data based on the directivity data while appropriately performing thinning of the data points, and outputs the coded bit stream including the coded directivity data. In this way, by appropriately performing thinning of the data points, the data amount of the directivity data to be transmitted to the client, that is, the transmission amount of the directivity data can be reduced. As a result, occurrence of a transmission delay and an increase in the transmission rate can be suppressed.

### <Description of Thinning Processing>

Meanwhile, in step S15 in FIG. 8, the data points are thinned out to generate the coded directivity data.

At this time, for example, in a case where the target data modeling method is selected as the thinning method, the bit rate control is performed such that the data including the coded directivity data and the recording point restoration information becomes the data amount assumed in advance, that is, the data of about the assumed bit rate.

In such bit rate control, it is necessary to prioritize data points such as which data point is selected as a recording data point.

As an example, in each recording data point selection method, a method of selecting a recording data point while changing a parameter (hereinafter, also referred to as an adjustment parameter) for determining a recording data point (thinning data point) is considered. The adjustment parameter can also be said to be a parameter for adjusting the number of recording data points.

For example, in the case of the threshold processing method, the threshold Threshold is the adjustment parameter, in the case of the discretization method, the step width for discretization is the adjustment parameter, and in the case of the modulation method, the modulation frequency f is the adjustment parameter. Note that, in the modulation method, parameters related to the modulation velocity v and the function g (d) may also be used as the adjustment parameters.

In this case, for example, the recording data point is selected by a predetermined adjustment parameter, and the data amount (hereinafter, also referred to as a recording data amount) of the data including the coded directivity data and the recording point restoration information according to the selection result is calculated.

Then, the adjustment parameter is changed until the bit rate corresponding to the recording data amount becomes equal to or higher than the assumed bit rate, and the number of recording data points gradually increases.

Note that the present invention is not limited thereto, and the recording data amount may be adjusted such that the number of recording data points gradually decreases by changing the adjustment parameter. In such a case, for example, the value of the adjustment parameter is changed (adjusted) until the bit rate corresponding to the recording data amount becomes equal to or less than the assumed bit rate.

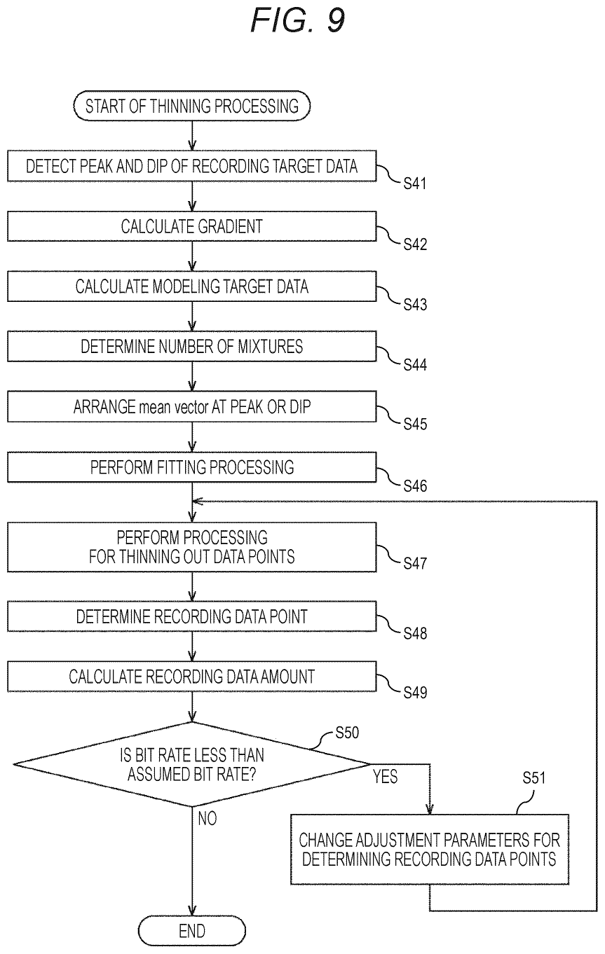

Hereinafter, the thinning processing performed by the server 11 will be described with reference to the flowchart of FIG. 9. This thinning processing is performed as a part of the processing of steps S14 and S15 in FIG. 8 in a case where the target data modeling method is selected as the thinning method.

In step S41, the thinning processing unit 33 detects a peak and a dip of the recording target data on the spherical surface on the basis of the recording target data of each data point. That is, peaks and dips of the values of the recording target data distributed on the spherical surface are detected.

As described above, the recording target data is the directional gain in the non-parametric method, the recording target data is the residual data in the hybrid recording method, and the recording target data is the prediction residual data in the prediction coding method.

In step S42, the thinning processing unit 33 calculates the gradient of the recording target data on the spherical surface on the basis of the recording target data of each data point. For example, a difference between the recording target data of the data points adjacent to each other is calculated as a gradient.

In step S43, for each data point, the thinning processing unit 33 calculates the modeling target data by weighting and adding the recording target data at the data point and the gradient of the recording target data at the data point.

In step S44, the thinning processing unit 33 determines the number of distributions constituting the mixture model when modeling the modeling target data, that is, the number of mixtures.

For example, the number of mixtures may be determined in advance, may be selected (designated) by a creator or the like, may be determined by the number of peaks or dips detected in step S41, or may be determined on the basis of modeling target data or recording target data.

As an example, the number of mixtures may be determined on the basis of, for example, a maximum value or a minimum value of any data of the modeling target data, the recording target data, and the gradient of the recording target data. Furthermore, the number of mixtures may be determined in advance for each sound source type or for each frequency.

In step S45, the thinning processing unit 33 arranges the mean vector, that is, the vector γ₁ at the peak or the dip of the recording target data obtained in step S41.

In step S46, the thinning processing unit 33 performs fitting processing on the basis of the modeling target data of each data point, the number of mixtures determined in step S44, and the mean vector arranged in step S45.

By this fitting processing, the modeling target data of each data point is represented by a mixture model including the distribution of the number of mixtures determined in step S44 and having a mean vector at the position arranged in step S45.

That is, by estimating the model parameters such as the parameter concentration degree K, the modeling target data is modeled by the mixture model. As a result of such modeling, model parameters of the modeling target data are obtained.

In step S47, the thinning processing unit 33 performs processing for thinning out the data points on the basis of the mixture model obtained by modeling.

In step S48, the thinning processing unit 33 determines (selects) the recording data point on the basis of the result of the processing in step S47. That is, an index indicating each data point to be a recording data point is selected, and then, arrangement (array) of one or a plurality of recording data points is determined.

Here, specific examples of steps S47 and S48 will be described. In step S47 or step S48, the processing is performed using the above-described adjustment parameter.

For example, it is assumed that the threshold processing method is selected as the recording data point selection method in the target data modeling method. In such a case, the thinning processing unit 33 compares a value at each data point of the mixture model that is the modeling target data after modeling with a predetermined threshold Threshold as an adjustment parameter.

Then, the thinning processing unit 33 selects, as a recording data point, a data point whose value in the mixture model is equal to or larger than the threshold Threshold among the data points of the mixture model. In this case, a data point having a value less than the threshold Threshold is set as a thinning data point.

Note that, as described above, the data point at which the value is equal to or less than the threshold Threshold may be set as the recording data point, or the value at the data point and the threshold Threshold may be compared for each distribution (mixture) constituting the mixture model.

Furthermore, for example, in a case where the discretization method is selected as the recording data point selection method, the thinning processing unit 33 discretizes the mixture model that is the modeling target data after modeling on the basis of the step width for discretization as the adjustment parameter. As a result, the region of the spherical surface representing the mixture model is divided into a plurality of discretization regions corresponding to the discretization range determined by the step width at the time of discretization.

The thinning processing unit 33 determines (selects) the recording data point on the basis of the discretized mixture model, that is, the division result into each discretization region, and the above-described predetermined standard.

That is, for example, one or a plurality of data points satisfying a specific condition among data points included in the discretization region is set as recording data points. At this time, for example, one or more recording data points is always selected from one discretization region.

As an example, for example, a data point at a position closest to the vector γ₁ is set as a recording data point. As another example, for example, among the data points included in the discretization region, one or a plurality of data points having a value closest to the median value of the discretization range corresponding to the discretization region as the value of the original mixture model before discretization is set as the recording data point.

Furthermore, for example, in a case where the modulation method is selected as the recording data point selection method, the thinning processing unit 33 performs AM modulation on the mixture model that is the modeling target data after modeling on the basis of the modulation parameter such as the modulation frequency f. For example, the AM modulation is performed by the calculation of Formula (10) described above. Here, the modulation frequency f is used as the adjustment parameter.

The thinning processing unit 33 determines a recording data point on the basis of a value at each data point of the modulation model obtained by the AM modulation and threshold information such as a range specifying distance and a range specifying threshold.

Specifically, for example, a data point included in a range within a predetermined range specific distance from the position of the peak value in the modulation model is set as the recording data point. Furthermore, for example, a data point at which the value of the modulation model is equal to or greater than a predetermined range specifying threshold value may be set as the recording data point.

When the recording data points are determined as described above, the data points other than the recording data points are set as thinning data points.

In step S49, the thinning processing unit 33 calculates the recording data amount on the basis of the determination result of the recording data points, that is, the thinning result, and the result of the processing according to the recording method in step S12 of FIG. 8.

That is, as described in step S14 and step S15 of FIG. 8, the directivity data coding unit 21 performs coding and the like on the recording target data of the recording data point, and generates the coded directivity data and the recording point restoration information. Then, the thinning processing unit 33 obtains (calculates) an amount of data including the generated coded directivity data and the recording point restoration information as a recording data amount.

Note that, in a case where the recording data amount can be obtained by calculation without actually generating the coded directivity data and the recording point restoration information, the coded directivity data and the recording point restoration information may not be generated, and only the recording data amount may be calculated for the time being.

In step S50, the thinning processing unit 33 determines whether or not the bit rate corresponding to the recording data amount obtained in step S49 is less than a target assumed bit rate.

In a case where it is determined in step S50 that the bit rate is less than the assumed bit rate, thereafter, the processing proceeds to step S51.

In this case, since there is still a margin in the recording data amount, that is, the bit rate of data to be transmitted, more data points are set as recording data points and more recording target data is transmitted in step S51.

That is, in step S51, the thinning processing unit 33 changes the adjustment parameters for determining the recording data points, in other words, the thinning data points.

Specifically, for example, in the case of the threshold processing method, the threshold Threshold set to 1.0 in the initial value is lowered by a predetermined value. Furthermore, for example, in the case of a discretization method, the step width for discretization is set to a smaller value, and discretization to a larger discretization range (discretization region) is performed. Furthermore, for example, in the case of a modulation method, the modulation frequency f is increased by a predetermined value and changed to a larger value.

After the processing of step S51 is performed, the processing returns to step S47, and the above-described processing is repeatedly performed. In this case, in steps S47 and S48, the processing is performed using the changed adjustment parameter.

On the other hand, in a case where it is determined in step S50 that the bit rate is equal to or higher than the assumed bit rate, the recording data amount becomes the assumed data amount, and thus the thinning processing ends.

In this case, the directivity data coding unit 21 supplies the finally generated coded directivity data and recording point restoration information to the output unit 23, and then, the processing of step S17 in FIG. 8 is performed.

As described above, the server 11 adjusts the recording data amount, that is, controls (adjusts) the bit rate of data to be transmitted, by changing the adjustment parameter. In this way, it is possible to transmit more data by using as many data points as possible as recording data points within an assumed bit rate range.

### <Configuration Example of Information Processing Apparatus>

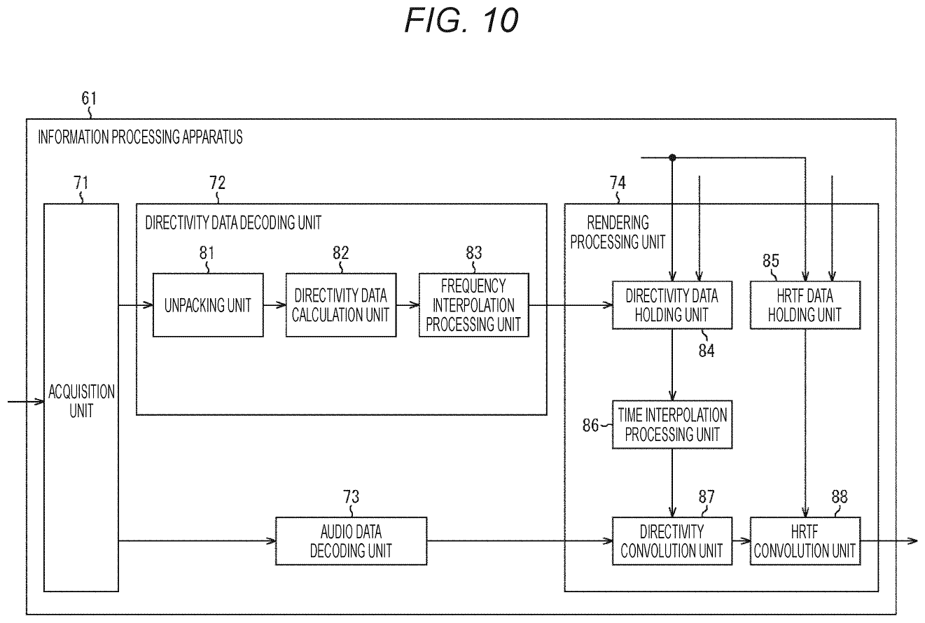

An information processing apparatus that acquires a coded bit stream output from the server 11 and functions as a client that generates output audio data for reproducing a sound of content is configured as illustrated in FIG. 10, for example. An information processing apparatus 61 illustrated in FIG. 10 includes, for example, a personal computer, a smartphone, a tablet, a head mounted display, a game device, or the like.

The information processing apparatus 61 includes an acquisition unit 71, a directivity data decoding unit 72, an audio data decoding unit 73, and a rendering processing unit 74.

The acquisition unit 71 acquires (receives) the coded bit stream output from the server 11, and extracts coded directivity data, recording point restoration information, and coded audio data from the coded bit stream. The acquisition unit 71 supplies the coded directivity data and the recording point restoration information to the directivity data decoding unit 72, and supplies the coded audio data to the audio data decoding unit 73.

The directivity data decoding unit 72 calculates the directivity data from the coded directivity data and the recording point restoration information.

The directivity data decoding unit 72 includes an unpacking unit 81, a directivity data calculation unit 82, and a frequency interpolation processing unit 83.

The unpacking unit 81 extracts data included in the coded directivity data and the recording point restoration information by performing unpacking and decoding on the coded directivity data and the recording point restoration information supplied from the acquisition unit 71, and supplies the data to the directivity data calculation unit 82.

The directivity data calculation unit 82 calculates (restores) the directivity data on the basis of the data supplied from the unpacking unit 81, and supplies the directivity data to the frequency interpolation processing unit 83.

For example, the directivity data calculation unit 82 appropriately specifies the data point set as the recording data point on the basis of the recording point restoration information, and calculates the recording target data at the position different from the recording data point on the basis of the recording target data of the recording data point.

The frequency interpolation processing unit 83 performs interpolation processing in the frequency direction on the directivity data supplied from the directivity data calculation unit 82, and supplies directivity data obtained as a result to the rendering processing unit 74.

The audio data decoding unit 73 decodes the coded audio data supplied from the acquisition unit 71, and supplies the resultant audio data of each object to the rendering processing unit 74.

Furthermore, in a case where the coded metadata is included in the coded bit stream, the audio data decoding unit 73 decodes the coded metadata supplied from the acquisition unit 71, and supplies metadata obtained as a result to the rendering processing unit 74.

The rendering processing unit 74 generates output audio data on the basis of the directivity data supplied from the frequency interpolation processing unit 83 and the audio data supplied from the audio data decoding unit 73. That is, the rendering processing unit 74 performs rendering processing using at least the directivity data and the audio data, and generates output audio data.

The rendering processing unit 74 includes a directivity data holding unit 84, an HRTF data holding unit 85, a time interpolation processing unit 86, a directional convolution unit 87, and an HRTF convolution unit 88.

The viewpoint position information, the listener direction information, the object position information, and the object direction information are supplied to the directivity data holding unit 84 and the HRTF data holding unit 85 according to designation by the user or the like, measurement by a sensor or the like, or the like.

For example, the viewpoint position information is information indicating a viewpoint position (listening position) in a three-dimensional space of a user (listener) viewing the content, and the listener direction information is information indicating a direction of a face of the user viewing the content in the three-dimensional space.

Furthermore, in a case where the coded metadata is included in the coded bit stream, the object position information and the object direction information are extracted from the metadata obtained by decoding the coded metadata and supplied to the directivity data holding unit 84 and the HRTF data holding unit 85.

In addition, the sound source type information obtained by being extracted from the metadata or the like is also supplied to the directivity data holding unit 84, and the user ID indicating the user who views the content is appropriately supplied to the HRTF data holding unit 85.

The directivity data holding unit 84 holds the directivity data supplied from the frequency interpolation processing unit 83. Further, the directivity data holding unit 84 reads directivity data corresponding to the supplied viewpoint position information, listener direction information, object position information, object direction information, and sound source type information from the held directivity data, and supplies the directivity data to the time interpolation processing unit 86.

The HRTF data holding unit 85 holds the HRTF for each of a plurality of directions viewed from the user (listener) for each user indicated by the user ID.

The HRTF data holding unit 85 reads the HRTF corresponding to the supplied viewpoint position information, listener direction information, object position information, object direction information, and user ID from the held HRTFs, and supplies the HRTF to the HRTF convolution unit 88.

The time interpolation processing unit 86 performs interpolation processing in the time direction on the directivity data supplied from the directivity data holding unit 84, and supplies the directivity data obtained as a result to the directional convolution unit 87.

The directional convolution unit 87 convolves the audio data supplied from the audio data decoding unit 73 and the directivity data supplied from the time interpolation processing unit 86, and supplies the resultant audio data to the HRTF convolution unit 88. By the convolution of the directivity data, the directional characteristics of the object (sound source) are added to the audio data.

The HRTF convolution unit 88 convolves the audio data supplied from the directional convolution unit 87, that is, the audio data in which the directivity data is convolved, and the HRTF supplied from the HRTF data holding unit 85, and outputs the audio data obtained as a result as output audio data. By convolution of the HRTF, it is possible to obtain the output audio data in which the sound of the object is localized at the position of the object viewed from the user (listener).

Note that, here, an example in which convolution processing of the HRTF is performed as rendering processing of the audio data will be described. More specifically, it can be said that convolution of the directivity data is a part of the rendering processing. However, the present invention is not limited thereto, and processing using vector based amplitude panning (VBAP), binaural room impulse response (BRIR), HOA, or the like may be performed as the rendering processing.

In this case, for example, in the rendering processing, after the directivity data is convolved into the audio data of the object, VBAP or the like is performed to generate the output audio data. Furthermore, the HRTF convolution unit 88 may convert the M-channel (M>2) audio data into the 2-channel audio data and output the 2-channel audio data, for example, by convoluting the HRTF or BRIR. In this way, for example, when viewing with left and right two-channel devices such as headphones, earphones, hearing aids, and sound collectors, it is possible to obtain output audio data in which the sound of the object is localized at the position of the object viewed from the user (listener), and it is possible to provide a stereophonic sound experience with a more realistic feeling. Note that it can be said that metadata of an object (audio data) is also used in the rendering processing.

### <Description of Directivity Data Generation Processing>

Next, the operation of the information processing apparatus 61 will be described.

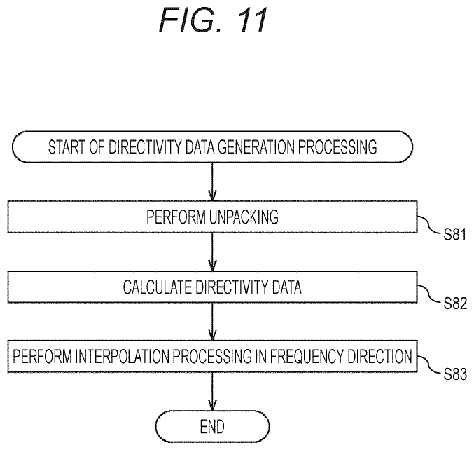

First, directivity data generation processing performed when the information processing apparatus 61 generates directivity data of each sound source type will be described. That is, the directivity data generation processing by the information processing apparatus 61 will be described below with reference to the flowchart of FIG. 11.

The directivity data generation processing is started when the acquisition unit 71 receives (acquires) the coded bit stream transmitted from the server 11, and the acquisition unit 71 supplies the unpacking unit 81 with the coded directivity data and the recording point restoration information extracted from the coded bit stream.

In step S81, the unpacking unit 81 performs unpacking and decoding on the coded directivity data and the recording point restoration information supplied from the acquisition unit 71.

For example, the unpacking unit 81 decodes the coding directivity gain, the coding residual data, or the coding prediction residual data at each data point included in the coded directivity data by a decoding method corresponding to the coding method in the directivity data coding unit 21, and supplies the decoded data to the directivity data calculation unit 82.

Furthermore, in a case where the coded directivity data includes model parameters and prediction coefficients, the unpacking unit 81 supplies the model parameters and the prediction coefficients to the directivity data calculation unit 82, and also supplies the recording point restoration information to the directivity data calculation unit 82.

Note that, in a case where thinning is not performed and recording point restoration information is not included in the coded bit stream, the recording point restoration information is not supplied to the directivity data calculation unit 82.

Furthermore, in a case where the recording method information and the thinning method information are extracted from the coded bit stream in the acquisition unit 71, the unpacking unit 81 supplies the recording method information and the thinning method information supplied from the acquisition unit 71 to the directivity data calculation unit 82.

In step S82, the directivity data calculation unit 82 calculates (generates) the directivity data on the basis of the data (information) supplied from the unpacking unit 81, and supplies the directivity data to the frequency interpolation processing unit 83.

For example, the directivity data calculation unit 82 performs processing according to the recording method or the thinning method specified by the recording method information or the thinning method information supplied from the unpacking unit 81, and restores the directivity data, that is, the directivity gain of each data point.

For example, in a case where the recording method is a non-parametric method, the directivity gain obtained by decoding the coding directivity gain is supplied from the unpacking unit 81 to the directivity data calculation unit 82. The directivity data calculation unit 82 sets the supplied data including the directivity gains of the data points as it is as directivity data.

Furthermore, for example, in a case where the recording method is the hybrid recording method, the directivity data calculation unit 82 calculates (restores) the mixture model representing the directivity data on the basis of the model parameter supplied from the unpacking unit 81. Then, the directivity data calculation unit 82 adds the value at the position of the data point of the mixture model and the residual data supplied from the unpacking unit 81 for each data point, and then, the directivity data including the directivity gain at each data point is obtained.

Furthermore, for example, in a case where the recording method is a prediction coding method, the directivity data calculation unit 82 generates (calculates) the directivity data on the basis of the model parameter, the prediction residual data, and the prediction coefficient supplied from the unpacking unit 81. In this case, in a case where the recording point restoration information including the symmetry specifying information is supplied from the unpacking unit 81, the directivity data calculation unit 82 also uses the prediction order ID included in the symmetry specifying information for generation of the directivity data.

Specifically, for example, the directivity data calculation unit 82 calculates the mixture model representing the directivity data on the basis of the model parameter, and calculates the prediction value of each data point on the basis of the prediction coefficient and the residual data of some data points already obtained by prediction. Note that, more specifically, for some data points, residual data is stored in the coded bit stream instead of prediction residual data.

For example, in a case where the symmetry specifying information is included in the recording point restoration information, the directivity data calculation unit 82 calculates the prediction value of the residual data at each data point in the prediction order specified by the prediction order ID included in the symmetry specifying information. Note that the prediction order may be determined in advance.

The directivity data calculation unit 82 adds the value at the position of the data point of the mixture model, the prediction residual data supplied from the unpacking unit 81, and the prediction value calculated on the basis of the prediction coefficient for each data point, so that the directivity data including the directivity gain at each data point is obtained.

By the above processing, in a case where thinning is not performed, the directional gains at all the data points are obtained, and in a case where thinning is performed, the directional gains at the recording data points of all the data points are obtained.

In a case where thinning is performed, the directivity data calculation unit 82 specifies a thinning data point, in other words, a recording data point on the basis of the recording point restoration information supplied from the unpacking unit 81, and appropriately calculates a directivity gain of the thinning data point.

For example, in a case where the thinning method is the fixed point designation method, the directivity data calculation unit 82 specifies the profile indicated by the profile flag on the basis of the profile flag included in the recording point restoration information.

When the profile is specified, the data point set as the recording data point can be specified. Therefore, which recording data point the directivity gain obtained by the above processing belongs to is specified. That is, the recording data point and the directional gain at the recording data point are associated with each other.

For example, in the coded bit stream, in what order the data such as the coding directivity gain of each data point is stored, that is, the order of the data points in which the data is stored is determined in advance. Therefore, if which data point is set as the recording data point can be specified, which data stored in the coded bit stream is the data of which recording data point can be specified.

When the recording data point is specified, which data point is the thinning data point is specified. Therefore, in order to restore the original directivity data, the directivity data calculation unit 82 calculates the directivity gain at the thinning data point on the basis of the directivity gain of the data point in the vicinity of the thinning data point for each thinning data point.

In this case, for example, the directivity data calculation unit 82 calculates the directivity gain of the thinning data point by performing the interpolation processing on the basis of the directivity gains of one or a plurality of recording data points in the vicinity of the thinning data point.

As a specific interpolation processing method, for example, bilinear interpolation using azimuth angles and elevation angles of a spherical surface, interpolation using a Voronoi diagram, spline interpolation, interpolation using a Gaussian kernel, interpolation using spherical harmonic expansion, and the like can be considered. Note that the method of the interpolation processing is not limited to the case of the fixed point designation method, and may be any method such as bilinear interpolation even in the case of other thinning methods.

Furthermore, in a case where there is a specific definition of data point arrangement according to a use case, the coordinates (position) of the data point for which the directional gain is calculated (generated) by the interpolation processing only need to be such that the directional gain of the data point at the position defined by the definition is calculated.

In a case where there is no definition of the data point arrangement, the position (coordinates) where the directional gain by interpolation is actually required is only required to be set as the position of the data point, and the directional gain may be obtained by the interpolation processing.

That is, it is not always necessary to calculate the directional gain of the data point set as the thinning data point, and the directional gain of the data point located at a position different from that of the recording data point may be obtained by interpolation processing or the like as necessary.

Specifically, for example, the directional gain may be obtained only for some of the all thinning data points. In addition, a position different from both the data point serving as the recording data point and the data point serving as the thinning data point may be set as a new data point, and the directional gain of the data point may be obtained.

As a specific example of the definition of the data point arrangement, the data points may be arranged at discrete positions in the elevation direction. In this case, for example, the positions can be arranged at predetermined angular intervals such as intervals of 10 degrees or intervals of 30 degrees from the position where the elevation angle is 0 degrees.

Furthermore, as another example of the definition of the data point arrangement, it is also conceivable to arrange the data points in accordance with a t-design (spherical t-design) arrangement so as to be distributed as uniformly as possible on the spherical surface.

Note that, in the following, a case where the directional gain of the thinning data point is calculated will be described as an example. However, the directional gain of which data point is obtained by interpolation processing or the like is not limited to the fixed point designation method, and the similarity applies to the case of other thinning methods.

By the above processing, the directivity data including the directivity gain of the necessary data point in the case where the thinning method is the fixed point designation method is obtained.

In addition, for example, in a case where the thinning method is the target data modeling method, the directivity data calculation unit 82 specifies the recording data points and the thinning data points on the basis of the recording region specifying information included in the recording point restoration information. Then, the directivity data calculation unit 82 calculates directivity gains of the thinning data points by interpolation processing or the like on the basis of the directivity gains of the recording data points, and obtains directivity data including the directivity gains of the data points.

Note that details of specification of the recording data point and the like in the target data modeling method and calculation of the directivity gain at the thinning data point will be described later.

Furthermore, for example, in a case where the thinning method is the hybrid thinning method, the directivity data calculation unit 82 performs processing similar to the case of the fixed point designation method described above and processing similar to the case of the target data modeling method. As a result, the recording data points and the thinning data points are specified, and the directional gain at the thinning data points is obtained by interpolation processing or the like.

In this case, the data point set as the recording data point is specified on the basis of the specification result of the recording data point based on the profile flag in the fixed point designation method and the specification result of the recording data point by the threshold processing based on the mixture model in the target data modeling method. Specifically, for example, the data point set as the recording data point by the processing in the case of at least one of the fixed point designation method and the target data modeling method is set as the final recording data point.

For example, in a case where the thinning method is the symmetry using method, the directivity data calculation unit 82 specifies the data point serving as the recording data point and the data point serving as the thinning data point on the basis of the symmetry specifying information included in the recording point restoration information.

Specifically, for example, the directivity data calculation unit 82 specifies the symmetric property of the prediction residual data on the basis of the prediction order ID, the center position information, the axis information, and the like included in the symmetry specifying information, and specifies the recording data point and the thinning data point from the specification result.

As an example, for example, in a case where the symmetric property is bilaterally symmetric, a data point in the right-half region with respect to the symmetric axis is regarded as a recording data point, and a data point in the left-half region with respect to the symmetric axis is regarded as a thinning data point. As a result, the recording data point and the directional gain at the recording data point are associated with each other.

The directivity data calculation unit 82 calculates directivity gains of the thinning data points by interpolation processing or the like on the basis of the directivity gains of the recording data points, and obtains directivity data including the directivity gains of the data points.

When the directivity data including the directivity gain of each data point is obtained for each frequency (frequency band) for each sound source type as described above, the directivity data calculation unit 82 supplies the directivity data to the frequency interpolation processing unit 83.

Note that the interpolation processing for obtaining the directivity gain of the data points that are not the recording data points such as the thinning data points may be performed by the time interpolation processing unit 86 of the rendering processing unit 74 instead of step S82.

In step S83, the frequency interpolation processing unit 83 performs interpolation processing in the frequency direction on the directivity data supplied from the directivity data calculation unit 82, and supplies the directivity data obtained by the interpolation processing to the directivity data holding unit 84 to hold.

For example, it is assumed that the audio data of the object is data in a frequency domain, and the audio data has a frequency component value for each of a plurality of frequency bins. In such a case, in the interpolation processing in the frequency direction, for example, interpolation processing of calculating a directivity gain of a necessary bin is performed such that the directivity data has a directivity gain for all frequency bins in which the audio data has a frequency component value.

Specifically, for example, the frequency interpolation processing unit 83 performs interpolation processing based on the directivity gains of a plurality of bins (frequencies) of a predetermined data point in the directivity data, so that a directivity gain of a new frequency (bin) at the same data point that does not exist in the original directivity data is calculated. By such interpolation processing in the frequency direction, it is possible to obtain directivity data including directivity gains at more frequencies.

When the interpolation processing in the frequency direction is performed and the directivity data after the interpolation processing is held in the directivity data holding unit 84, the directivity data generation processing ends.

As described above, the information processing apparatus 61 generates the directivity data from the coded directivity data, specifies the recording data points and the thinning data points on the basis of the recording point restoration information, and appropriately calculates the directivity gain of the thinning data points or the like by the interpolation processing or the like.

In this way, thinning can be appropriately performed on the coding side, and the transmission amount of the directivity data can be reduced. As a result, occurrence of a transmission delay and an increase in the transmission rate can be suppressed.

### <Description of Data Point Interpolation Processing>

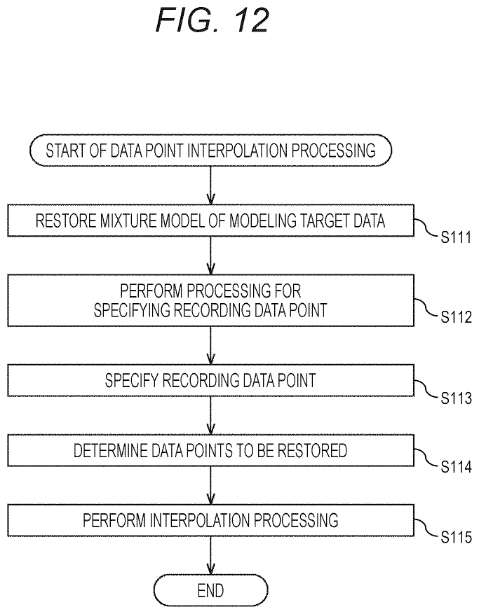

In a case where the thinning method is the target data modeling method, in the information processing apparatus 61, for example, the data point interpolation processing illustrated in FIG. 12 is performed as a part of the processing of step S82 in FIG. 11. Hereinafter, data point interpolation processing by the information processing apparatus 61 will be described with reference to the flowchart in FIG. 12.

In step S111, the directivity data calculation unit 82 restores (generates) the mixture model of the modeling target data on the basis of the recording region specifying information included in the recording point restoration information supplied from the unpacking unit 81.

That is, the directivity data calculation unit 82 calculates the mixture model representing the modeling target data on the basis of the model parameters of the modeling target data included in the recording region specifying information.

In step S112, the directivity data calculation unit 82 performs processing for specifying a recording data point on the basis of the mixture model obtained in step S111 and the recording region specifying information supplied from the unpacking unit 81.

In this case, the directivity data calculation unit 82 can specify by which recording data point selection method in the target data modeling method the thinning, that is, the determination of the recording data point is performed on the server 11 side from the thinning method information and the like.

In step S113, the directivity data calculation unit 82 specifies the recording data point on the basis of the processing result of step S112. That is, the index indicating the data point set as the recording data point is specified, and the arrangement (array) of one or a plurality of recording data points is specified accordingly.

Here, specific examples of steps S112 and S113 will be described.

For example, in a case where thinning is performed by a threshold processing method, the directivity data calculation unit 82 compares the value at each data point of the mixture model of the modeling target data with the threshold Threshold included in the recording region specifying information. Then, the directivity data calculation unit 82 assumes that a data point at which the value in the mixture model is equal to or larger than the threshold Threshold is a recording data point.

That is, the data point set as the recording data point is specified by performing the threshold processing on the mixture model on the basis of the threshold Threshold.

Note that, the data point at which the value is equal to or less than the threshold Threshold may be set as the recording data point, or the value at the data point and the threshold Threshold may be compared (threshold processing) for each distribution (mixture) constituting the mixture model.

Furthermore, for example, in a case where thinning is performed by a discretization method, the directivity data calculation unit 82 discretizes the mixture model of the modeling target data on the basis of the step width included in the recording region specifying information. As a result, the region of the spherical surface representing the mixture model is divided into a plurality of discretization regions corresponding to the discretization range determined by the step width at the time of discretization.

The directivity data calculation unit 82 specifies the data point set as the recording data point on the basis of the division result into each discretization region and the predetermined reference used for determining the recording data point in steps S47 and S48 of FIG. 9.

Specifically, for example, one or a plurality of data points satisfying a specific condition among data points included in the discretization region, such as a data point located closest to the vector γ₁, is set as the recording data points.

Furthermore, for example, in a case where thinning is performed by a modulation method, the directivity data calculation unit 82 performs AM modulation on the mixture model of the modeling target data on the basis of a modulation parameter such as the modulation frequency f included in the recording region specifying information. For example, the AM modulation to the mixture model is performed by the calculation of Formula (10) described above.

The directivity data calculation unit 82 specifies the recording data point on the basis of a value at each data point of the modulation model obtained by the AM modulation and threshold information such as a range specifying distance and a range specifying threshold included in the recording region specifying information. That is, the data point set as the recording data point is specified by performing the threshold processing on the modulation model on the basis of the threshold information.

Specifically, for example, a data point included in a range within a predetermined range specific distance from the position of the peak value in the modulation model is set as the recording data point. Furthermore, for example, a data point at which the value of the modulation model is equal to or greater than a predetermined range specifying threshold value may be set as the recording data point.

When the recording data point is specified as described above, which recording data point has the directional gain obtained in step S82 of FIG. 11 is specified. That is, the recording data point and the directional gain at the recording data point are associated with each other. In addition, it is assumed that which data point is set as the thinning data point is specified from the specification result of the recording data point.

In step S114, the directivity data calculation unit 82 determines data points (hereinafter, also referred to as restoration data points) to be restored among the data points other than the recording data points on the basis of the specification result of the recording data points.

For example, all the thinning data points may be set as the restored data points, or some thinning data points or positions different from the thinning data points and the recording data points may be set as the restored data points. In addition, which data point should be set as the restoration data point may be determined in advance, or may be designated by a user or the like.

In step S115, the directivity data calculation unit 82 performs interpolation processing on the basis of the directivity gains of one or a plurality of data points in the vicinity of the restored data points, and calculates the directivity gains of the restored data points. In this case, as described above, the interpolation processing method may be any interpolation method such as bilinear interpolation or interpolation using a Voronoi diagram.

When the interpolation processing is performed and the directivity data including the necessary directivity gain of the data point is obtained, the data point interpolation processing ends.

As described above, the information processing apparatus 61 specifies the recording data point on the basis of the recording region specifying information, and appropriately calculates the directivity gain of the necessary data point by the interpolation processing or the like. In this way, even in a case where thinning is performed on the coding side, the directivity gain of the necessary data point can be obtained by calculation, and the transmission amount of the directivity data can be reduced.

### <Description of Output Audio Data Generation Processing>

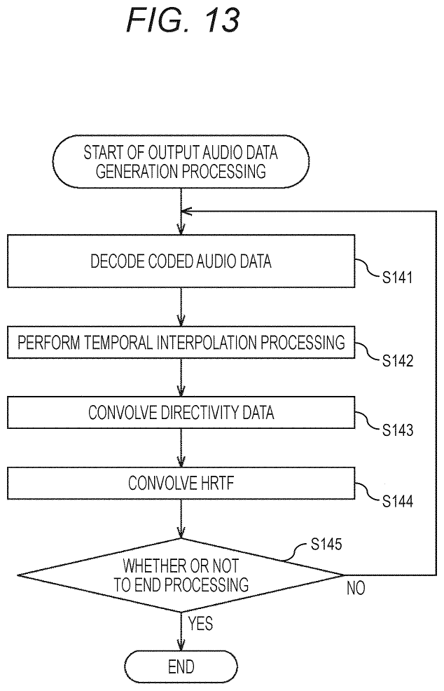

The output audio data generation processing performed by the information processing apparatus 61 will be described with reference to the flowchart in FIG. 13. This output audio data generation processing is performed at an arbitrary timing after the directivity data generation processing described with reference to FIG. 11 is performed.

In step S141, the audio data decoding unit 73 decodes the coded audio data supplied from the acquisition unit 71, and supplies the resultant audio data to the directional convolution unit 87. For example, audio data in a frequency domain is obtained by decoding.

Note that, in a case where the coded metadata is supplied from the acquisition unit 71, the audio data decoding unit 73 decodes the coded metadata, and supplies the object position information, the object direction information, and the sound source type information included in the metadata obtained as a result to the directivity data holding unit 84 and the HRTF data holding unit 85 as appropriate.

Further, the directivity data holding unit 84 supplies the directivity data corresponding to the supplied viewpoint position information, listener direction information, object position information, object direction information, and sound source type information to the time interpolation processing unit 86.

For example, the directivity data holding unit 84 specifies the relationship between the viewpoint position (listening position) of the object and the user in the three-dimensional space from the viewpoint position information, the listener direction information, the object position information, and the object direction information, and specifies the data point corresponding to the specification result.

As an example, for example, assuming that a direction from the object to the viewpoint position is a viewpoint position direction, a position on the sphere surface in the viewpoint position direction as viewed from the center of the sphere in which the data points of the directivity data are arranged is specified as the target data point position. Note that there may be no actual data point at the target data point position.

The directivity data holding unit 84 extracts a directivity gain of each bin (frequency band) in a plurality of data points in the vicinity of the specified target data point position from the directivity data of the sound source type indicated by the sound source type information.

Then, the directivity data holding unit 84 supplies data including the directional gains of the respective bins at the plurality of extracted data points to the time interpolation processing unit 86 as directivity data according to the relationship between the position and direction of the object and the user (listener).

Further, the HRTF data holding unit 85 supplies the HRTF corresponding to the supplied viewpoint position information, listener direction information, object position information, object direction information, and user ID to the HRTF convolution unit 88.

Specifically, for example, the HRTF data holding unit 85 specifies the relative direction of the object viewed from the listener (user) as the object direction on the basis of the viewpoint position information, the listener direction information, the object position information, and the object direction information. Then, the HRTF data holding unit 85 supplies the HRTF in the direction corresponding to the object direction among the HRTFs in the respective directions corresponding to the user ID to the HRTF convolution unit 88. Note that the HRTF data holding unit 85 may supply parameters such as a room impulse response (RIR), a BRIR, an interaural time difference (ITD), and an interaural intensity difference (IID) to the HRTF convolution unit 88, in addition to the HRTF.

In step S142, the time interpolation processing unit 86 performs temporal interpolation processing on the directivity data supplied from the directivity data holding unit 84, and supplies directivity data obtained as a result to the directional convolution unit 87.

For example, the time interpolation processing unit 86 calculates the directional gain of each bin at the target data point position by the interpolation processing on the basis of the directional gain of each bin at the plurality of data points included in the directivity data. That is, the directional gain at a new data point (target data point position) different from the original data point is calculated by the interpolation processing.

The time interpolation processing unit 86 supplies data including the directional gain of each bin at the target data point position to the directional convolution unit 87 as directivity data obtained by the temporal interpolation processing.

In step S143, the directional convolution unit 87 convolves the audio data supplied from the audio data decoding unit 73 and the directivity data supplied from the time interpolation processing unit 86, and supplies the resultant audio data to the HRTF convolution unit 88.

In step S144, the HRTF convolution unit 88 convolves the audio data supplied from the directional convolution unit 87 and the HRTF supplied from the HRTF data holding unit 85, and outputs the output audio data obtained as a result. Here, the HRTF convolution unit 88 may convolve RIR, BRIR, ITD, IID, or the like in addition to the HRTF.

In step S145, the information processing apparatus 61 determines whether or not to end the processing.

For example, in a case where coded audio data of a new frame is supplied from the acquisition unit 71 to the audio data decoding unit 73, it is determined in step S145 that the processing is not terminated. On the other hand, for example, in a case where the coded audio data of the new frame is not supplied from the acquisition unit 71 to the audio data decoding unit 73 and the output audio data of all the frames of the content is generated, it is determined in step S145 that the processing is ended.

In a case where it is determined in step S145 that the processing is not yet ended, thereafter, the processing returns to step S141, and the above-described processing is repeatedly performed.

On the other hand, in a case where it is determined in step S145 that the processing is ended, the information processing apparatus 61 ends the operation of each unit, and the output audio data generation processing ends.

As described above, the information processing apparatus 61 selects appropriate directivity data and HRTFs, and convolves the directivity data and the HRTFs with the audio data to obtain output audio data. By doing so, it is possible to realize high-quality audio reproduction with a more realistic feeling in consideration of the directional characteristics of the object (sound source) and the relationship between the position and orientation of the object and the listener.

According to the present technology as described above, data points can be appropriately thinned out by modeling data, using data symmetry, or the like, and the amount of data to be transmitted can be reduced. As a result, occurrence of a transmission delay and an increase in the transmission rate can be suppressed.

### <Configuration Example of Computer>

Incidentally, the above-described series of processing can be executed by hardware or software. In a case where a series of processing is executed by the software, a program forming the software is installed on a computer. Here, examples of the computer include a computer incorporated in dedicated hardware, and for example, a general-purpose personal computer capable of executing various functions by installing various programs or the like.

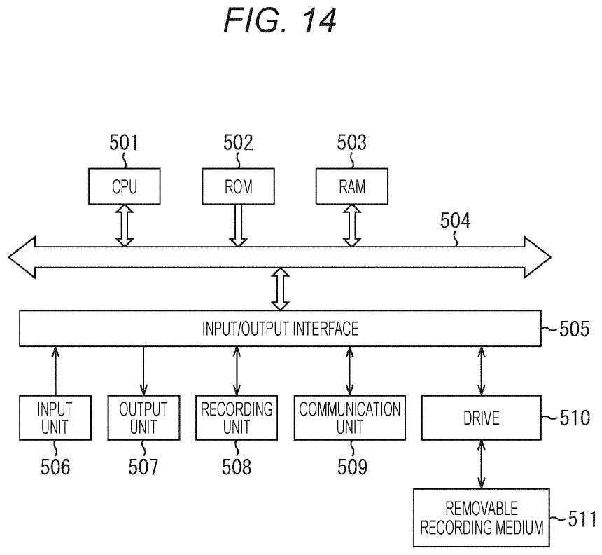

FIG. 14 is a block diagram illustrating a configuration example of hardware of a computer that executes the series of processing described above according to a program.

In the computer, a central processing unit (CPU) 501, a read only memory (ROM) 502, and a random access memory (RAM) 503 are mutually connected by a bus 504.

Moreover, an input/output interface 505 is connected to the bus 504. An input unit 506, an output unit 507, a recording unit 508, a communication unit 509, and a drive 510 are connected to the input/output interface 505.

The input unit 506 includes a keyboard, a mouse, a microphone, an image sensor, or the like. The output unit 507 includes a display, a speaker, and the like. The recording unit 508 includes a hard disk, a non-volatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program recorded in the recording unit 508 into the RAM 503 via the input/output interface 505 and the bus 504, and executes the program, so as to perform the above-described series of processing.

The program executed by the computer (CPU 501) can be provided by being recorded on the removable recording medium 511 as a package medium and the like, for example. Furthermore, the program can be provided via a wired or wireless transmission medium such as a local area network, the Internet, or digital satellite broadcasting.

In the computer, the program can be installed in the recording unit 508 via the input/output interface 505 by mounting the removable recording medium 511 on the drive 510.

Furthermore, the program can be received by the communication unit 509 via the wired or wireless transmission medium to be installed on the recording unit 508. In addition, the program can be installed in the ROM 502 or the recording unit 508 in advance.

Note that the program to be executed by the computer may be a program that executes processing in time series in accordance with an order described in the present description, or may be a program that executes processing in parallel or at a necessary timing such as when a call is made.

Furthermore, the embodiments of the present technology are not limited to the above-described embodiments, and various modifications are possible without departing from the scope of the present technology.

For example, the present technology can have a configuration of cloud computing in which one function is shared and processed in cooperation by a plurality of devices via a network.

Furthermore, each step described in the flowchart described above may be performed by a single device, or may be performed by a plurality of devices in a shared manner.

Moreover, in a case where a plurality of pieces of processing is included in one step, the plurality of pieces of processing included in the one step can be executed by one device or executed by a plurality of devices in a shared manner. Furthermore, the present technology may also have following configurations.

(1)

An information processing apparatus including:
an acquisition unit that acquires target data at a recording data point among a plurality of data points arranged on a spherical surface, and recording point restoration information for specifying the data point serving as the recording data point; and
a calculation unit that specifies the data point serving as the recording data point on the basis of the recording point restoration information, and calculates the target data at a position different from the recording data point on the basis of the target data at the recording data point.
   (2)

The information processing apparatus according to (1), in which
the recording point restoration information is information different from ID information for uniquely identifying the data point.
   (3)

The information processing apparatus according to (1) or (2), in which
the recording point restoration information includes profile information that is a profile indicating a set of a plurality of the recording data points and indicates any of a plurality of profiles in which arrangement of the recording data points is different from each other.
   (4)

The information processing apparatus according to (1) or (2), in which
the recording point restoration information includes model parameters constituting a mixture model obtained by modeling modeling target data based on the target data by the mixture model including one or a plurality of distributions, and
the calculation unit specifies the data point set as the recording data point on the basis of the mixture model obtained from the model parameters.
   (5)

The information processing apparatus according to (4), in which
the one or plurality of distributions includes at least one of a vMF distribution and a Kent distribution.
   (6)

The information processing apparatus according to (4) or (5), in which
the modeling target data is calculated on the basis of at least one of the target data and a gradient of the target data.
   (7)

The information processing apparatus according to any one of (4) to (6), in which
the calculation unit specifies the data point set as the recording data point by performing threshold processing on the mixture model on the basis of a predetermined threshold.
   (8)

The information processing apparatus according to (7), in which
the calculation unit performs the threshold processing for each distribution constituting the mixture model.
   (9)

The information processing apparatus according to any one of (4) to (6), in which
the calculation unit specifies the data point set as the recording data point by discretizing the mixture model on the basis of a predetermined step width.
   (10)

The information processing apparatus according to any one of (4) to (6), in which
the calculation unit modulates the mixture model on the basis of a predetermined modulation frequency, and specifies the data point set as the recording data point on the basis of a modulation model obtained by modulation.
   (11)

The information processing apparatus according to (10), in which
the modulation is AM modulation.
   (12)

The information processing apparatus according to (10) or (11), in which
the calculation unit specifies the data point set as the recording data point by performing threshold processing on the modulation model on the basis of a predetermined threshold.
   (13)

The information processing apparatus according to (4), in which
the recording point restoration information includes the model parameter and profile information indicating any of a plurality of profiles that is a profile indicating a set of a plurality of the recording data points and in which arrangement of the recording data points is different from each other, and
the calculation unit specifies the data point set as the recording data point on the basis of a specification result of the recording data point based on the mixture model obtained from the model parameter and a specification result of the recording data point based on the profile information.
   (14)

The information processing apparatus according to (1) or (2), in which
the recording point restoration information includes symmetry specifying information regarding symmetry of the target data, and
the calculation unit specifies the data point set as the recording data point on the basis of the symmetry specifying information.
   (15)

The information processing apparatus according to any one of (1) to (14), in which
the calculation unit calculates the target data at a position different from the recording data point by interpolation processing.
   (16)

The information processing apparatus according to any one of (1) to (15), in which
the target data is data regarding directivity of a sound source.
   (17)

The information processing apparatus according to (16), further including
a rendering processing unit that performs rendering processing using the target data and audio data.
   (18)

The information processing apparatus according to (17), in which
the audio data is audio data of an object.
   (19)

The information processing apparatus according to (17) or (18), in which
the rendering processing unit performs the rendering processing using VBAP, HRTE, BRIR, or HOA.
   (20)

The information processing apparatus according to any one of (17) to (19), in which
the rendering processing unit performs the rendering processing using metadata of the object.
   (21)

The information processing apparatus according to (20), in which
the metadata includes at least any one of object position information, object direction information, sound source type information, priority information of the object, and spread information of the object.
   (22)

An information processing method including:
by an information processing apparatus,
acquiring target data at a recording data point among a plurality of data points arranged on a spherical surface and recording point restoration information for specifying the data point set as the recording data point; and
specifying the data point set as the recording data point on the basis of the recording point restoration information, and calculating the target data at a position different from the recording data point on the basis of the target data at the recording data point.
   (23)

A program for causing a computer to execute processing including the steps of:
acquiring target data at a recording data point among a plurality of data points arranged on a spherical surface, and recording point restoration information for specifying the data point serving as the recording data point; and
specifying the data point serving as the recording data point on the basis of the recording point restoration information, and calculating the target data at a position different from the recording data point on the basis of the target data at the recording data point.
   (24)

An information processing apparatus including:
a generation unit that determines one or a plurality of recording data points from among a plurality of data points arranged on a spherical surface, and generates recording point restoration information for specifying the data points set as the recording data points; and
an output unit that outputs a bit stream including the recording point restoration information and target data at the recording data points.

### REFERENCE SIGNS LIST

11 Server
21 Directional data coding unit
22 Audio data coding unit
23 Output unit
31 Modeling unit
32 Residual calculation unit
33 Thinning processing unit
61 Information processing apparatus
71 Acquisition unit
72 Directional data decoding unit
73 Audio data decoding unit
74 Rendering processing unit
82 Directivity data calculation unit

What is claimed is:

1. An information processing apparatus comprising:
an acquisition unit that acquires target data at a recording data point among a plurality of data points arranged on a spherical surface, and recording point restoration information for specifying the data point serving as the recording data point; and
a calculation unit that specifies the data point serving as the recording data point on a basis of the recording point restoration information, and calculates the target data at a position different from the recording data point on a basis of the target data at the recording data point.

2. The information processing apparatus according to claim 1, wherein
the recording point restoration information is information different from ID information for uniquely identifying the data point.

3. The information processing apparatus according to claim 1, wherein
the recording point restoration information includes profile information that is a profile indicating a set of a plurality of the recording data points and indicates any of a plurality of profiles in which arrangement of the recording data points is different from each other.

4. The information processing apparatus according to claim 1, wherein
the recording point restoration information includes model parameters constituting a mixture model obtained by modeling modeling target data based on the target data by the mixture model including one or a plurality of distributions, and
the calculation unit specifies the data point set as the recording data point on a basis of the mixture model obtained from the model parameters.

5. The information processing apparatus according to claim 4, wherein
the one or plurality of distributions includes at least one of a vMF distribution and a Kent distribution.

6. The information processing apparatus according to claim 4, wherein
the modeling target data is calculated on a basis of at least one of the target data and a gradient of the target data.

7. The information processing apparatus according to claim 4, wherein
the calculation unit specifies the data point set as the recording data point by performing threshold processing on the mixture model on a basis of a predetermined threshold.

8. The information processing apparatus according to claim 7, wherein
the calculation unit performs the threshold processing for each distribution constituting the mixture model.

9. The information processing apparatus according to claim 4, wherein
the calculation unit specifies the data point set as the recording data point by discretizing the mixture model on a basis of a predetermined step width.

10. The information processing apparatus according to claim 4, wherein
the calculation unit modulates the mixture model on a basis of a predetermined modulation frequency, and specifies the data point set as the recording data point on a basis of a modulation model obtained by modulation.

11. The information processing apparatus according to claim 10, wherein
the modulation is AM modulation.

12. The information processing apparatus according to claim 10, wherein
the calculation unit specifies the data point set as the recording data point by performing threshold processing on the modulation model on a basis of a predetermined threshold.

13. The information processing apparatus according to claim 4, wherein
the recording point restoration information includes the model parameter and profile information indicating any of a plurality of profiles that is a profile indicating a set of a plurality of the recording data points and in which arrangement of the recording data points is different from each other, and
the calculation unit specifies the data point set as the recording data point on a basis of a specification result of the recording data point based on the mixture model obtained from the model parameter and a specification result of the recording data point based on the profile information.

14. The information processing apparatus according to claim 1, wherein
the recording point restoration information includes symmetry specifying information regarding symmetry of the target data, and
the calculation unit specifies the data point set as the recording data point on a basis of the symmetry specifying information.

15. The information processing apparatus according to claim 1, wherein
the calculation unit calculates the target data at a position different from the recording data point by interpolation processing.

16. The information processing apparatus according to claim 1, wherein
the target data is data regarding directivity of a sound source.

17. The information processing apparatus according to claim 16, further comprising
a rendering processing unit that performs rendering processing using the target data and audio data.

18. The information processing apparatus according to claim 17, wherein
the audio data is audio data of an object.

19. The information processing apparatus according to claim 17, wherein
the rendering processing unit performs the rendering processing using VBAP, HRTF, BRIR, or HOA.

20. The information processing apparatus according to claim 17, wherein
the rendering processing unit performs the rendering processing using metadata of the object.

21. The information processing apparatus according to claim 20, wherein
the metadata includes at least any one of object position information, object direction information, sound source type information, priority information of the object, and spread information of the object.

22. An information processing method comprising:
by an information processing apparatus,
acquiring target data at a recording data point among a plurality of data points arranged on a spherical surface and recording point restoration information for specifying the data point set as the recording data point; and
specifying the data point set as the recording data point on a basis of the recording point restoration information, and calculating the target data at a position different from the recording data point on a basis of the target data at the recording data point.

23. A program for causing a computer to execute processing including the steps of:
acquiring target data at a recording data point among a plurality of data points arranged on a spherical surface, and recording point restoration information for specifying the data point serving as the recording data point; and
specifying the data point serving as the recording data point on a basis of the recording point restoration information, and calculating the target data at a position different from the recording data point on a basis of the target data at the recording data point.

24. An information processing apparatus comprising:
a generation unit that determines one or a plurality of recording data points from among a plurality of data points arranged on a spherical surface, and generates recording point restoration information for specifying the data points set as the recording data points; and
an output unit that outputs a bit stream including the recording point restoration information and target data at the recording data points.
